(19) United States
(12) Patent Application Publication
(10) Pub. No.: US 2016/0082583 A1
(43) Pub. Date: Mar. 24, 2016

(54) MULTI-FUNCTIONAL POWER TOOL SYSTEM

(71) Applicant: BLACK & DECKER INC., Newark, DE (US)

(72) Inventors: Oleksiy P. SERGYEYENKO, Baldwin, MD (US); Trevor KOENIG, Lancaster, PA (US); Mark D. MILLER, Fawn Grove, PA (US); Kelly E. DYER, Silver Spring, MD (US); Frederick R. BEAN, Finksburg, MD (US); Marco A. MATTUCCI, Baltimore, MD (US); Tylan A. TSCHOPP, Baltimore, MD (US)

(21) Appl. No.: 14/858,442

(22) Filed: Sep. 18, 2015

Related U.S. Application Data
(60) Provisional application No. 62/053,003, filed on Sep. 19, 2014.
(60) Provisional application No. 62/196,547, filed on Jul. 24, 2015.

(51) Int. Cl. B25H 1/00; B23D 59/00; B25H 1/04; B23D 47/02

(52) U.S. Cl. CPC B25H 1/005; B23D 47/025; B23D 59/007; B25H 1/04

(57) ABSTRACT

A benchtop tool system having a broad variety of interchangeable heads and types of tools. Each interchangeable head can be a tool having a common attachment interface. The interchangeable tools can be engaged to and driven by a base unit which can be supported by a support arm. The support arm can be movable to configure the orientation of a tool to a desired position. The benchtop tool system can have a detachable stand which allows the benchtop tool system to be used in a variety of operating environments.

### CROSS-REFERENCE TO RELATED APPLICATIONS

This patent application is a nonprovisional application of and claims benefit of the filing date of copending U.S. provisional patent application No. 62/196,547 entitled “Multi-Functional Power Tool System” filed on Jul. 24, 2015.

This patent application is also a nonprovisional application of and claims benefit of the filing date of copending U.S. provisional patent application No. 62/053,003 entitled “Multi-Functional Power Tool System” filed on Sep. 19, 2014.

### INCORPORATION BY REFERENCE

This patent application incorporates by reference in its entirety copending U.S. provisional patent application No. 62/196,547 entitled “Multi-Functional Power Tool System” filed on Jul. 24, 2015.

This patent application also incorporates by reference in its entirety copending U.S. provisional patent application No. 62/053,003 entitled “Multi-Functional Power Tool System” filed on Sep. 19, 2014.

### FIELD OF THE INVENTION

The invention in its several and varied embodiments disclosed herein regards benchtop power tools.

### BACKGROUND OF THE INVENTION

Benchtop power tools (herein also as “benchtop tools”) are used in the construction trades. However, benchtop tools have a number of problems and deficiencies. Benchtop tools lack flexibility in the type of tool that can be used, are not flexible in how such tools are positioned and not flexible regarding how workpieces are processed by using such tools. These limitations result in the need for an operator to purchase or use different types of workbenches having different tools for different types of projects and the lack of flexibility in the use of each workbench results in difficulties in executing work tasks.

### SUMMARY OF THE INVENTION

This disclosure in its several and varied embodiments discloses a multifunctional benchtop power tool system having an efficient, operator friendly and useful connection section which allows a variety of different tool heads to be connected and powered by a motor and readily used by an operator.

In an embodiment, a benchtop tool system 10 can have: a platform 50; at least one of a rail 25 connected to the platform 50; a base unit 100 slidably mounted on the at least one of the rail 25, said base unit 100 including a motor 110 and a connection section 600; and a removable tool head 200 connected to the base unit 100 at the connection section 600.

The benchtop tool 1 can have a removable tool head 200 which includes a tool holder configured to hold a tool. The benchtop tool 1 can have a tool head 200 can have an attachment interface 500 receivable in the connection section 600.

The benchtop tool 1 can have an at least one rail which can run parallel to a surface of the platform 50. In an embodiment, the benchtop tool system 10 can have a connection section 600 which includes a first rotatable coupler 107 drivable by the motor 110 and the attachment interface 500 includes a second rotatable coupler 507 coupleable to the first rotatable coupler 107.

In an embodiment, the benchtop tool system 10 can have one of the attachment interface 500 and the connection section 600 which can have a projection and the other of the attachment interface 500 and the connection section 600 can have an opening; and in which the at least one projection 449 and the opening are moveable with respect to one another from a first position in which the projection 449 and opening are aligned to a second position in which the projection 449 and the opening are offset with respect to one another. In an embodiment, the benchtop tool system 10 can be adapted in which, in the first position, the projection 449 may pass through the opening so that the tool head 200 can be moved towards or away from the base unit 100. In an embodiment, the benchtop tool system 10 can be adapted such that, in the first position, the projection 449 may pass through the opening so that the second rotatable coupler 507 can be moved away from and out of engagement with the first rotatable coupler 107. In an embodiment, the benchtop tool system 10 can be adapted such that, in the first position, the projection 449 may pass through the opening so that the second rotatable coupler 507 can be moved towards and into engagement with the first rotatable coupler 107.

In an embodiment, the benchtop tool system 10 can be adapted such that, in the second position, the projection 449 is blocked and the tool head 200 is prevented from being moved away from the base unit 100. In an embodiment, the benchtop tool system 10 can be adapted such that, in the second position, the projection 449 is blocked and the second rotatable coupler 507 is prevented from moving away from and becoming disengaged with the first rotatable coupler 107.

The benchtop tool system 10 can have a coupling section which has a lock portion 650 adjacent to the opening 129. The benchtop tool system 10 can have a lock portion 650 which overlaps the projection 449 in the second position. The benchtop tool system 10 can have a projection 449 which has an inclined surface 559. The benchtop tool system 10 can have an inclined surface 559 which can engage the lock portion 650. The benchtop tool system 10 can have a number of projections 449 and a number of openings 129.

In an embodiment, the benchtop tool system 10 can have a number of projections 449 which can include a first projection and a second projection; and in which the number of openings includes a first opening and a second opening; and in which the first projection is sized differently than the second projection and the first opening is sized differently than the second opening such that the first projection can pass through the first opening but cannot pass through the second opening.

The benchtop tool 1 can have a base unit 100 which has a handle. The benchtop tool 1 can have a platform 50 which has a benchtop. The benchtop tool system 10 can have a benchtop which is generally flat. The benchtop tool system 10 can have a benchtop which is flat.

The benchtop tool 1 can have a removable tool head 200 which is a saw tool head 200. The benchtop tool 1 can have a removable tool head 200 which is a circular saw tool head 205. The benchtop tool 1 can have a removable tool head 200 which is a tile saw tool head 210. The benchtop tool 1 can have a removable tool head 200 which is a miter saw tool head 218.

In an embodiment, the benchtop tool 1 can have an at least one rail which can have a pair of rails 25. In an embodiment, the benchtop tool system 10 can have a pair of rails 25 which are parallel.

In an embodiment, the benchtop tool 1 can have a connection section 600 which can have a cavity 125 for receiving the attachment interface 500 in which in which the connection section 600 includes a lock-down member 620, comprising a number of openings, each separated by a locking portion 650; and in which the connection section 600 further can have a first rotatable coupler 107 driven by the motor 110.

In an embodiment, the benchtop tool system 10 can have at least one support arm connecting the platform 50 and at least one rail. In an embodiment, the benchtop tool system 10 can have a pair of support arms connecting the platform 50 and at least one rail 25.

In an embodiment, the benchtop tool system 10 can have at least one rail 25 which has a first end 11 and a second end 13 and in which the pair of support arms can have a first support arm at the first end 11 and a second support arm at the second end 13.

In an embodiment, the benchtop tool 1 can have an at least one rail which is pivotable with respect to the platform 50. In an embodiment, the benchtop tool system 10 can have at least one rail and the at least one support arm can be pivotable with respect to the platform 50.

In an embodiment, the benchtop tool system 10 of claim 29, in which the at least one support arm includes a groove; and a locking mechanism is disposed in the groove; and in which the locking mechanism can be engaged to lock the support arm 20 with respect to the platform 50; and in which the locking mechanism can be unlocked to allow the support arm to rotate with respect to the platform 50. In an embodiment, the support arm 20 can have a support arm frame 21, which have a plurality of members, such as a first frame support 21 and a second frame support 23.

The benchtop tool 1 can have a base unit 100 which can have a first rotatable coupler 107 drivable by the motor 110. The benchtop tool system 10 in which the tool head 200 can have a second rotatable coupler 507 coupleable to the first rotatable coupler 107 to be driven by the motor 110.

The benchtop tool system 10 in which the first rotatable coupler 107 can have a number of splines 118. The benchtop tool system 10 in which the second rotatable coupler 507 can have a number of recesses for receiving the splines 118. The benchtop tool system 10 in which the number of splines can have five (5) splines. The benchtop tool system 10 in which the number of splines can have six (6) splines. The benchtop tool system 10 in which number of splines can be 50 splines or less; such as 2, 3, 4, 5, 6, 7, 8, 9, 10, 11, 12, 16, or 18 or more splines.

In an embodiment, the benchtop tool system 10 can have a first rotatable coupler 107 which is a male coupler. In an embodiment, the benchtop tool system 10 can have a second rotatable coupler 507 which is a female coupler.

The benchtop tool system 10 can have a second rotatable coupler 507 which can have a number of splines. The benchtop tool system 10 can have a first rotatable coupler 107 which can have a number of recesses for receiving the splines. The benchtop tool system 10 in which number of splines of a rotatable coupler can be 50 splines or less; such as 2, 3, 4, 5, 6, 7, 8, 9, 10, 11, 12, 16 or 18 splines.

In an embodiment, the benchtop tool system 10 can have a second rotatable coupler 507 which is a male coupler. In an embodiment, the benchtop tool system 10 can have a first rotatable coupler 107 which is a female coupler.

In an embodiment, the benchtop tool system 10 can be adapted such that the first tool head 200 has a first tool head 200 tool which can rotate in a first direction and the second tool head 200 can have a second tool head 200 tool which can rotate in a second direction, opposite the first direction.

Optionally, the benchtop tool system 10 can have a first tool head 200 tool which is a saw blade. Optionally, the benchtop tool system 10 can have a first tool head 200 tool which is a circular saw blade. Optionally, the benchtop tool system 10 can have a second tool head 200 tool which is a saw blade. Optionally, the benchtop tool system 10 can have a second tool head 200 tool which is a tile saw blade.

In an embodiment, the benchtop tool system 10 can have a platform 50 having a power unit 106 slidably mounted on the at least one rail 25, said power unit 106 including a motor 110 and a connection section 600; a first tool head 200 selectably coupleable to the power unit 106; and a second tool head 200 selectably coupleable to the power unit 106. In an embodiment, the at least one rail 25 is connected directly, or indirectly, to the platform 50. In an embodiment, a plurality of rails 26 can be used.

In an embodiment, the benchtop tool system 10 can have a first tool head 200 which has a first tool head 200 tool which can rotate in a first direction; and in which the second tool head 200 can have a second tool head 200 tool which can rotate in a second direction, opposite the first direction.

In an embodiment, the benchtop tool system 10 can have a first tool head 200 which can have a transmission which can reverse the direction of rotation from an input rotation direction so that the first tool head 200 can rotate in the first direction.

In an embodiment, the benchtop tool system 10 can have a first tool head 200 which can have a tile saw and the benchtop tool system 10 can operate as a tile saw when the first tool head 200 is coupled to a power unit 106.

In an embodiment, the benchtop tool system 10 can have a second tool head 200 which can have a circular saw, and the benchtop tool system 10 can operate as a circular saw when the second tool head 200 is coupled to a power unit 106.

In an embodiment, the benchtop tool system 10 can have a tile saw tool head 210 which can have a transmission which can offset the tile saw blade such that an axis of rotation of the tile saw blade which is offset with an axis of rotation of the motor 110. Optionally, the benchtop tool system 10 of claim can have an axis of rotation of the tile saw blade which is offset with an axis of rotation of the motor 110 towards the platform 50.

In an embodiment, the benchtop tool system 10 can be adapted such that when the circular saw tool head 205 is coupled to the power unit 106, an axis of rotation of a circular saw blade is coincident with an axis of rotation of the motor 110.

In an embodiment, the benchtop tool system 10 can have a tool head 200 which can have an attachment interface 500 receivable in the connection section 600; and in which the connection section 600 has a cavity 125 for receiving the attachment interface 500; and in which the connection section 600 includes a lock-down member 620 which can have a number of openings separated by locking portions 650; and in which the connection section 600 can additionally have a first rotatable coupler 107 driven by the motor 110. The benchtop tool system 10 can have at least one rail which runs parallel to a surface of the platform 50.

In an embodiment, the benchtop tool system 10 can have a cavity 125 which is formed by a cavity housing 120 (herein also as “connection housing 120”), the lock-down member 620 is mounted on an end of the cavity housing 120; and in which the lock-down member 620 is rotatable with respect to at least a portion of the attachment interface 500 and/or one or more of the projection 449.

In an embodiment, the benchtop tool system 10 can have a lock-down member 620 which has a generally cylindrical member, and the locking portions 650 can have projections 449 projecting radially inwardly and the openings can be openings between the locking portions 650.

In an embodiment, a platform 50 base unit 100 for a benchtop tool system 10 can have a platform 50 including a benchtop surface configured to support a workpiece; at least one rail connected to the platform 50; a power unit 106 slidably mounted on the at least one rail, said power unit 106 including a base unit housing 102, a motor 110 housed in the base unit housing 102 and a connection section 600, the connection section 600 configured to removably receive an attachment interface 500 of a tool head 200; and in which the connection section 600 has a cavity 125 for receiving the attachment interface 500; and in which the connection section 600 includes a lock-down member 620 having a number of openings separated by locking portions 650; and in which the connection section 600 further has a first rotatable coupler 107 driven by the motor 110.

In an embodiment, the platform 50 base unit 100 can have at least one rail which runs parallel to a surface of the platform 50.

In an embodiment, the platform 50 base unit 100 can have a cavity 125 which is formed by a cavity housing 120, and the lock-down member 620 can be mounted on an end of the cavity housing 120; and the lock-down member 620 can be rotatable with respect to at least a portion of the attachment interface 500 and/or one or more of the projection 449.

In an embodiment, the platform 50 base unit 100 can have a lock-down member 620 which has a generally cylindrical member, and the locking portions 650 can have projections 449 projecting radially inwardly and the openings can be openings between the locking portions 650.

In an embodiment, a removable tool head 200 for a tool system can have: a tool head 200 housing; a tool holder configured to hold a tool; an attachment interface 500 configured to attach to a base unit 100, the attachment interface 500 comprising a first generally cylindrical section and a second generally cylindrical section, the second generally cylindrical section protruding from the first generally cylindrical section and having a smaller diameter than the second generally cylindrical section; in which the attachment interface 500 further has a plurality of projections 449 projecting radially outwardly from at least the first generally cylindrical section; and in which the attachment interface 500 further has a rotatable coupler, which is rotatable with respect to the first generally cylindrical section and the second generally cylindrical section.

The tool head 200 can have a number of projections 449. In an embodiment, the number of projections 449 of the tool head 200 can be 20 or fewer, such as 1, 2, 3, 4, 5, 6, 8, 10, or more projections 449.

In an embodiment, one or more projections 449 can be generally box-shaped lugs. In an embodiment, one or more projections 449 can have an inclined surface 559. In an embodiment, the one or more projections 449 can be a thread for a thread and screw connection.

In an embodiment, the tool head 200 can have a rotatable coupler which can have a female coupler comprising recesses configured to receive one or more splines of a male coupler.

### BRIEF DESCRIPTION OF THE DRAWINGS

The present invention in its several aspects and embodiments solves the problems discussed above and significantly advances the technology of benchtop tools. The present invention can become more fully understood from the detailed description and the accompanying drawings, wherein:

FIG. 1 shows general information regarding the benchtop tool system attachment interface and connection section;

FIG. 2 shows a cross section of the benchtop tool system attachment interface and connection section;

FIG. 3A shows indexing features regarding the benchtop tool system tool attachment interface;

FIG. 3B shows a detailed top view of lug dimensions;

FIG. 3C shows a detailed top view of connection housing opening dimensions;

FIG. 3D shows a section view of the connection housing with the lugs configured in a locked position;

FIG. 4A shows radial alignment features regarding the benchtop tool system attachment interface;

FIG. 4B shows a cross section of attachment interface inserted into the connection housing and oriented in a locked position;

FIG. 5 shows an axial lock mechanism securing the benchtop tool system attachment interface;

FIG. 6A shows additional details regarding the axial lock mechanism;

FIG. 6B shows a cross section of the axial lock mechanism;

FIG. 7 shows a bench tool system having a saw at a center position;

FIG. 8A shows a bench tool system having a saw at a forward position;

FIG. 8B shows a cross section of a bench tool system having a saw head;

FIG. 9 shows a bench tool system having a saw at a rearward position;

FIG. 10 shows a bench tool system having a saw at a first beveled position;

FIG. 11 shows a bench tool system having a saw at a second beveled position;

FIG. 12 shows a bench tool system having a saw head attached;

FIG. 13 shows a bench tool system having a saw head detached;

FIG. 14A shows a first perspective of a bench unit stand;

FIG. 14B shows another perspective of a bench unit stand;

FIG. 14C shows a first perspective of a standing configuration of a bench unit stand;

FIG. 14D shows a second perspective of a standing configuration of a bench unit stand;

FIG. 15A shows additional details of the bench unit stand;

FIG. 15B shows an end view of the bench unit stand;

FIG. 15C shows a worm's eye view of the bench unit stand;

FIG. 16 shows a bench tool system without a cutting head;

FIG. 17A shows a bench tool system with a tile saw head;

FIG. 17B shows a cross section of a bench tool system having a tile saw head;

FIG. 18 shows a water trough of a bench tool system;

FIG. 19 shows a bench tool system with a tile saw head at a beveled orientation; and

FIG. 20 shows tile offset tile saw offset gears.

Herein, like reference numbers in one figure refer to like reference numbers in another figure.

### DETAILED DESCRIPTION OF THE INVENTION

The present application in its many and varied embodiments describes a benchtop tool system 10 which is convertible to create different tool functionalities. In one aspect, the benchtop tool system 10 can be used with a wide variety of different tool heads which can be connected and used with a wide variety of workpieces. In another aspect, the configuration of the members of the benchtop tool system 10 can be changed to readily allow work on a workpiece.

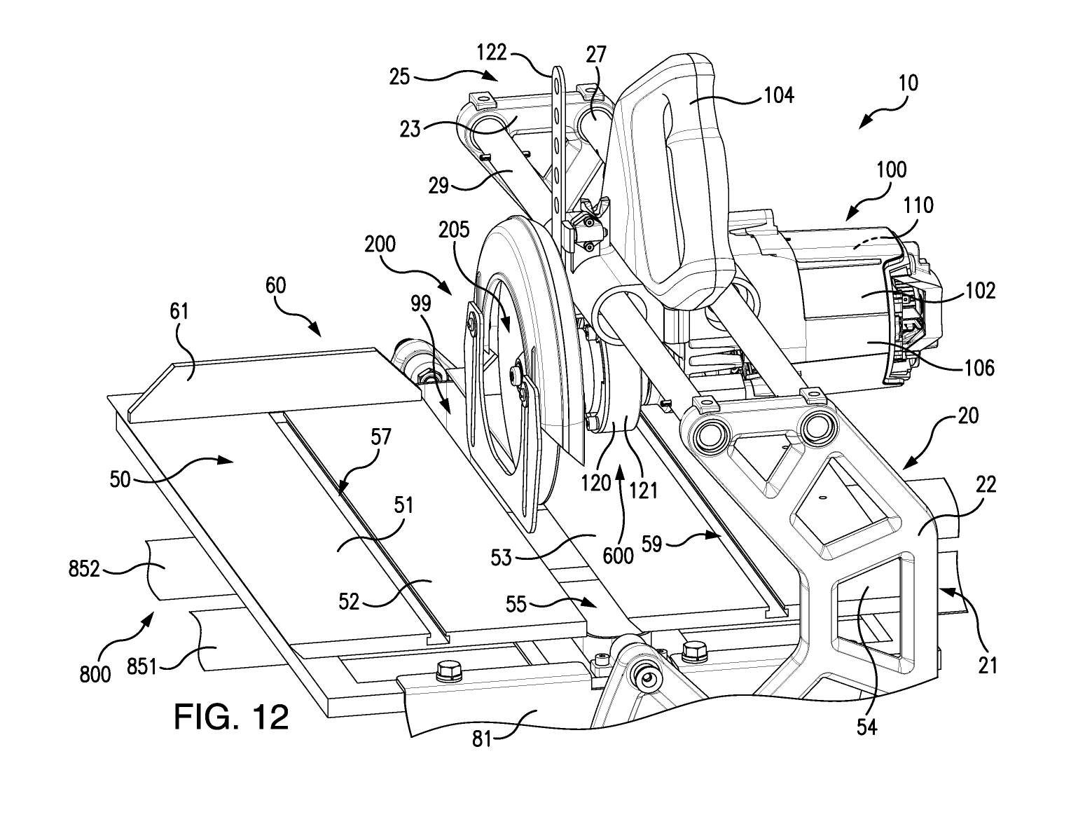

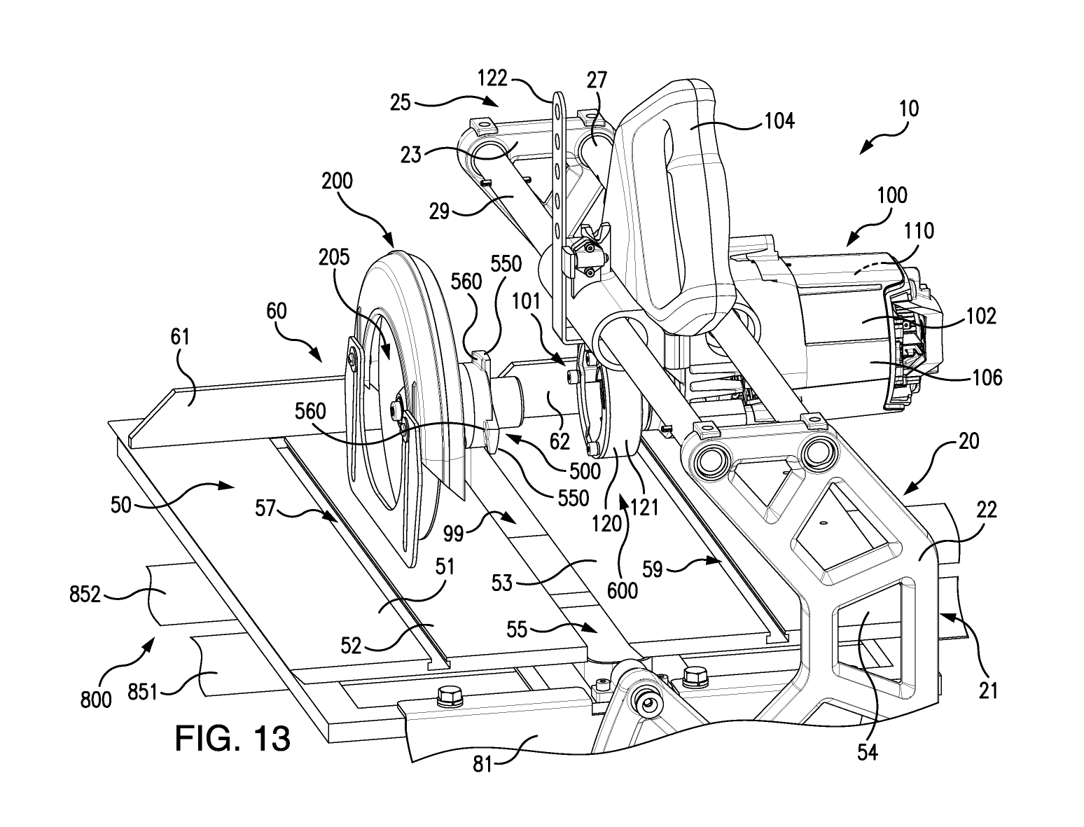

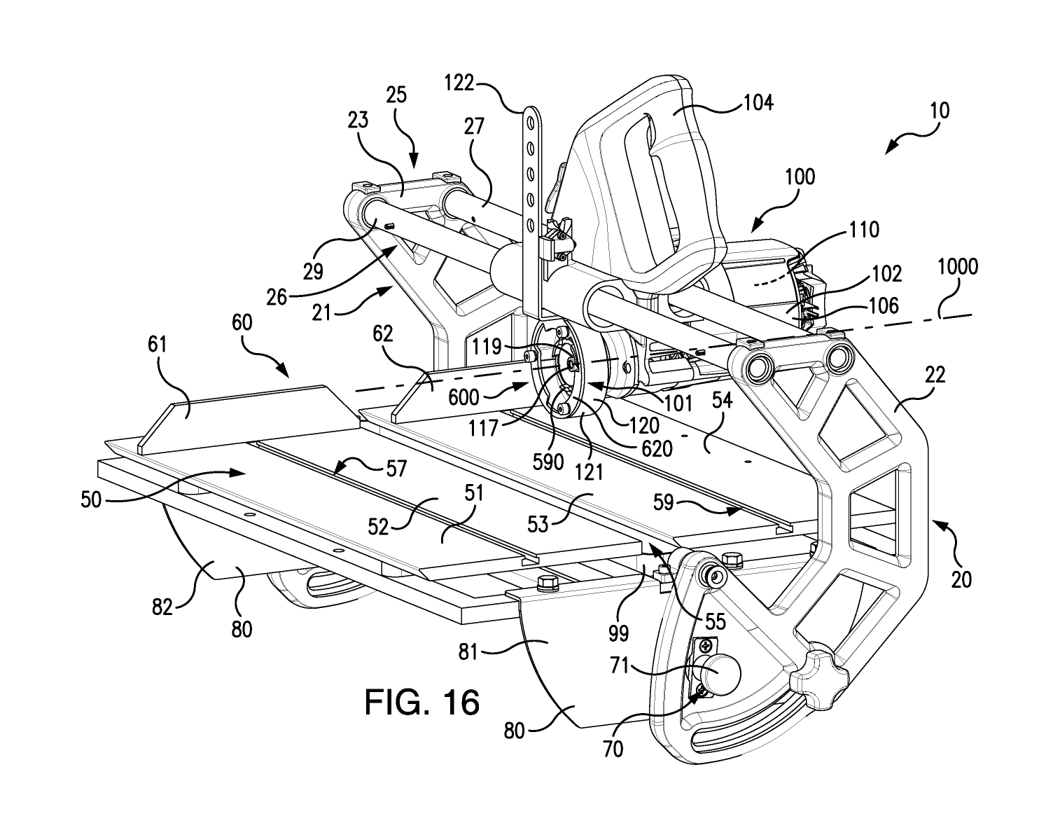

In an embodiment of the benchtop tool system 10 can have a base unit 100 having a power unit 106 which can have a motor 110 and a connection section 600. The power unit 106 can be enclosed at least in part in a base unit housing 102. The base unit 100 can slide on a pair of rails 25. The motor 110 of power unit 106 which can also be at least in part housed in the base unit housing 102. A base unit handle 104 allows a user to slide the base unit 100 and the power unit 106 along the rails 25. The power unit 106 also has a connection section 600 which is capable of receiving an attachment interface 500 from a tool head 200. This allows various and different of the tool heads 200 to be inserted, coupled and secured to the power unit 106. An individual tool head 200 may also be unsecured, decoupled and removed from the power unit 106 and replaced with another tool head 200 of a different type. Many types of the tool heads 200 can be attached and used with the power unit 106 and then removed. When the tool head is attached, the power unit 106 can drive the tool head 200 which has been attached and/or coupled to the power unit 106. For example, a circular saw tool head 205 may be connected to the power unit 106 as shown in, for example, FIG. 12, such that the circular saw tool head 205 can be driven by the power unit 106. This tool head 200 can be removed, as shown in FIG. 13, and another tool head 200 can then be coupled to the power unit 106, such as the tile saw tool head 210 shown in FIGS. 16-19.

The varied and different embodiments of the tool head 200 can have different tool functionality and be different types of tools used for different purposes. In nonlimiting example, these differences can include the speed at which various tool heads operate, the direction of rotation of the rotating parts of the different tool heads, the type of tools and purpose of the tools. The different variations of the tool head 200 can extend to the operational function provided by the tool head 200. For example, a circular saw tool head 205 has a very different purpose and operation than a sander tool head 220.

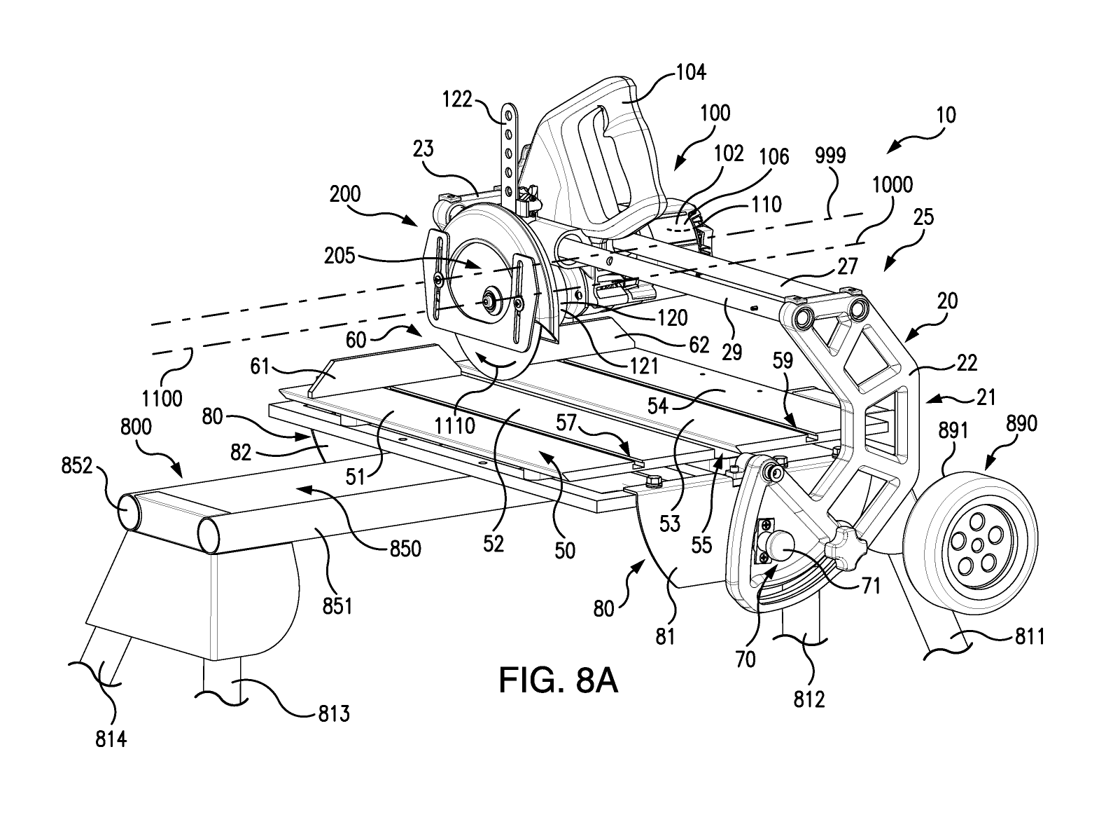

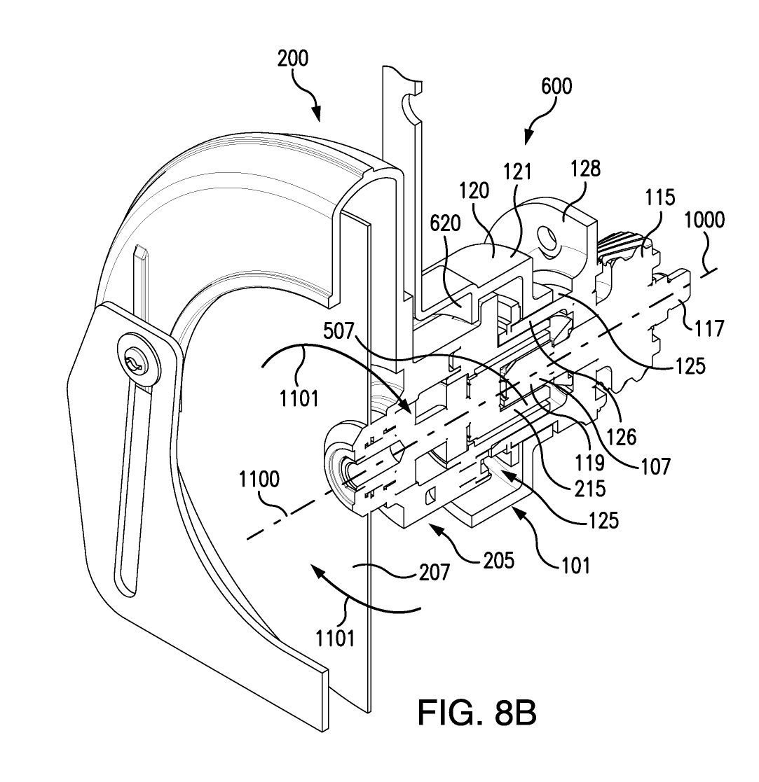

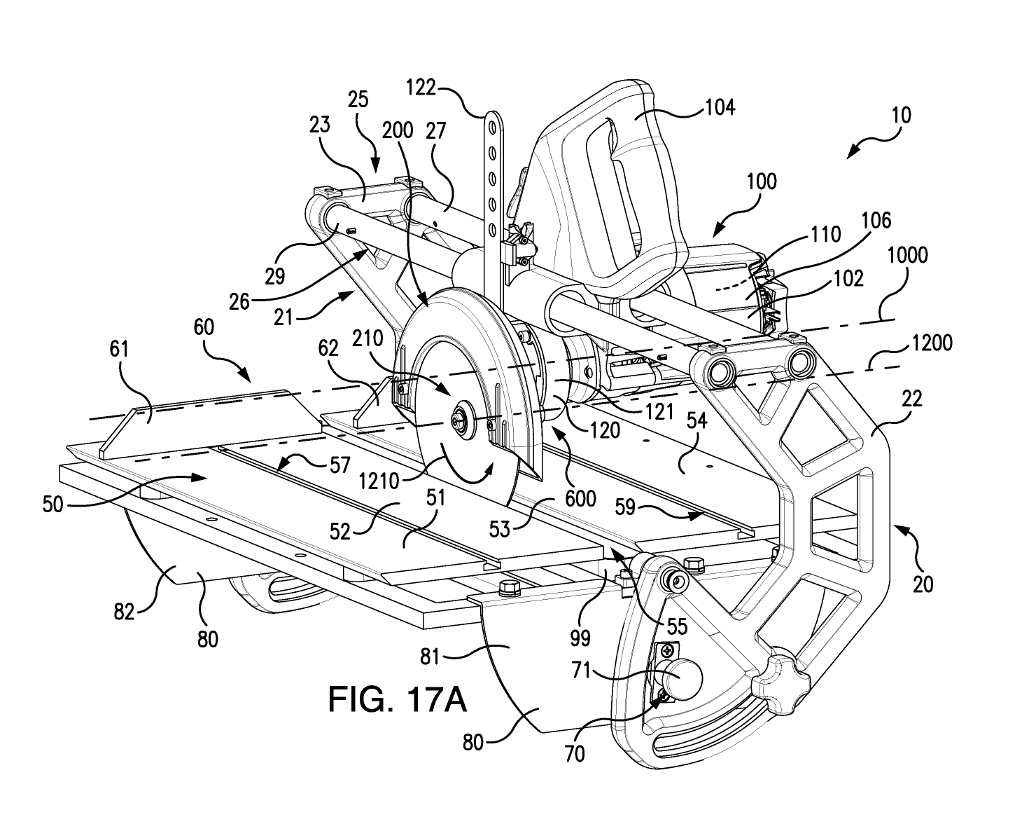

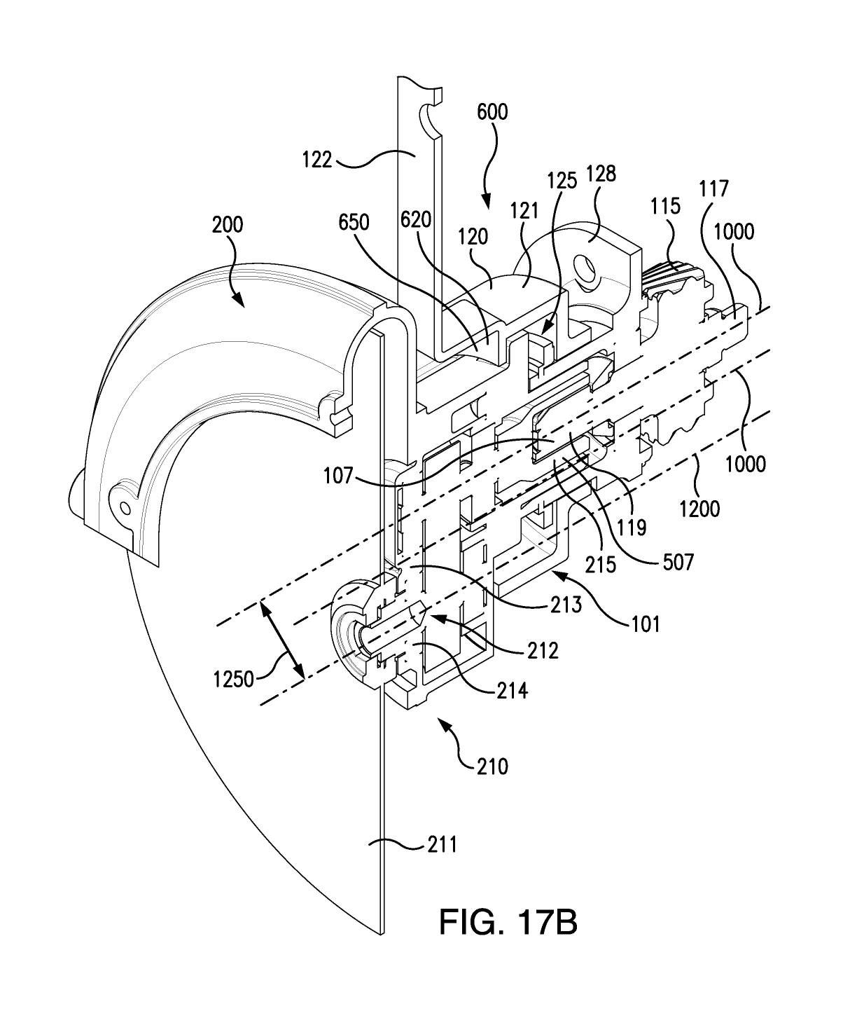

In a nonlimiting example, the figures of the present application illustrate a circular saw tool head 205 and a tile saw tool head 210. The circular saw tool head 205 of FIG. 12 can rotate in a first direction (for example, clockwise) while the tile saw tool head 210 of FIGS. 17-19 can rotate in an opposite direction (for example, counterclockwise) from the circular saw. Additionally, the axis about which the respective blades of the circular saw's head and the tile saw's head rotate can be different. For example, the tile saw tool head 210 can rotate about an axis which is closer to the benchtop platform (herein as “platform” 50) of the benchtop tool system 10 than the circular saw (see, e.g., FIG. 8A, 8B versus FIGS. 17A, 17B 19 and 20). As shown in FIG. 8A, rotor axis 999 of motor 110 of power unit 106 can be parallel to the base drive gear rotational axis 1000. The circular saw blade can rotate about an circular saw axis of rotation 1100 that is coincident with a base drive gear rotational axis 1000.

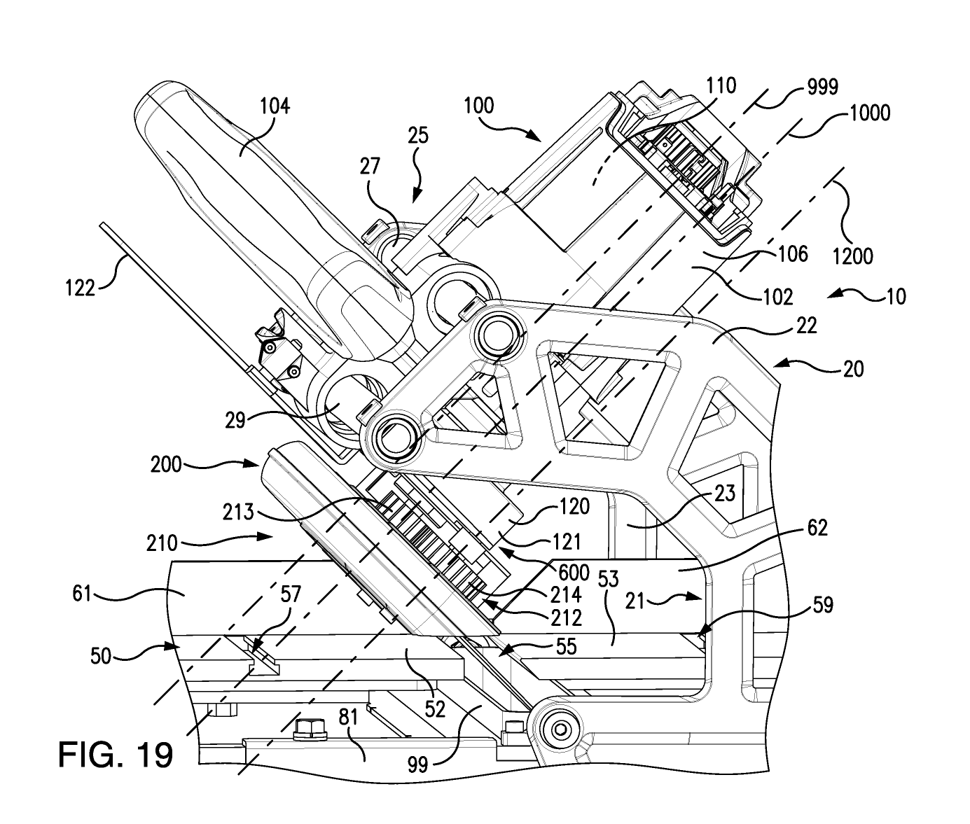

In an embodiment, the tile saw tool head 210 can be offset downwardly by a pair of tile saw offset gears 212, as shown in FIG. 19. The tile saw tool head 210 therefore can rotate along a tile saw axis of rotation 1200 that is parallel, but offset from the rotational axis of the motor 110. As shown in FIG. 19, the rotor axis 999 can be parallel with either or both of the base drive gear rotational axis 1000 and the tile saw axis of rotation.

Another difference between the tile saw tool head 210 and the circular saw tool head 205 is that the tile saw tool head 210 can rotate at a different speed than the circular saw tool head 205. In an embodiment, the tile saw tool head 210 can rotate at a slower speed (i.e., less and/or fewer revolutions per minute) than the circular saw tool head 205. Finally, the tile saw tool head 210 carries a tile saw blade while the circular saw tool head 205 carries a circular saw blade. In an embodiment, the tile saw tool head 210 can rotate in a different direction than the circular saw tool head 205.

Other tool heads, such as, for example, a sander tool head 220 and a router tool head 230 are contemplated and be varieties of the tool head 200 and used with and be part of the benchtop tool system 10. An embodiment of the present application will now be described in further detail in conjunction with the various figures.

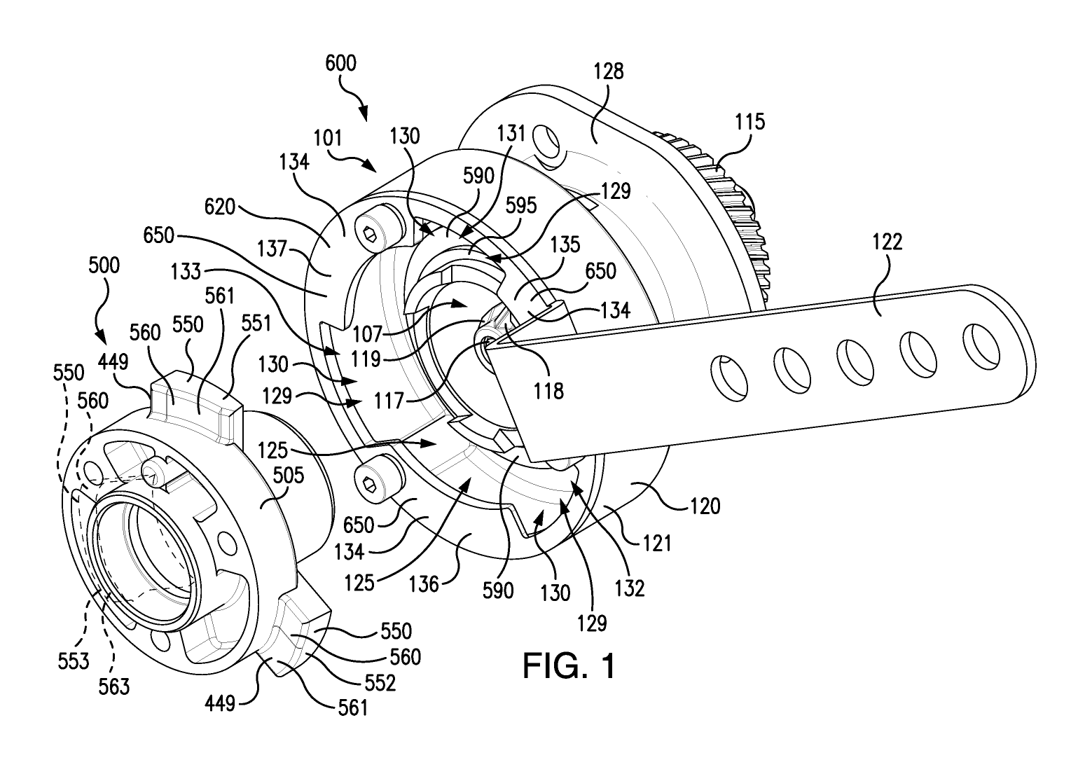

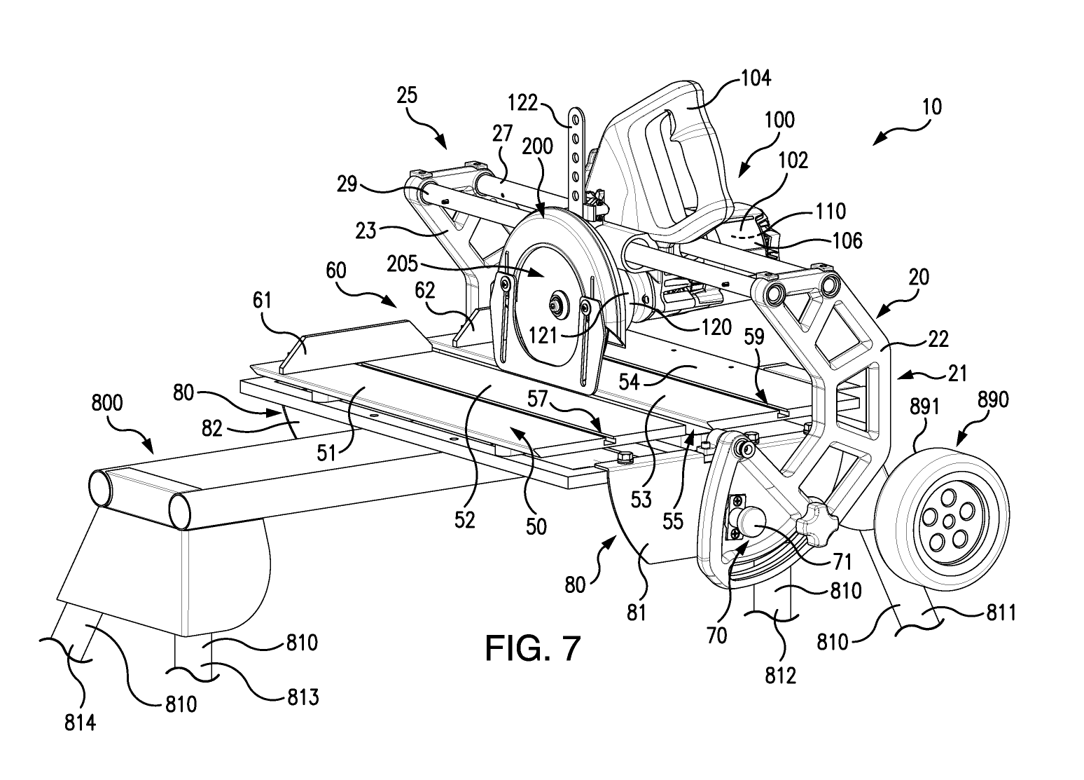

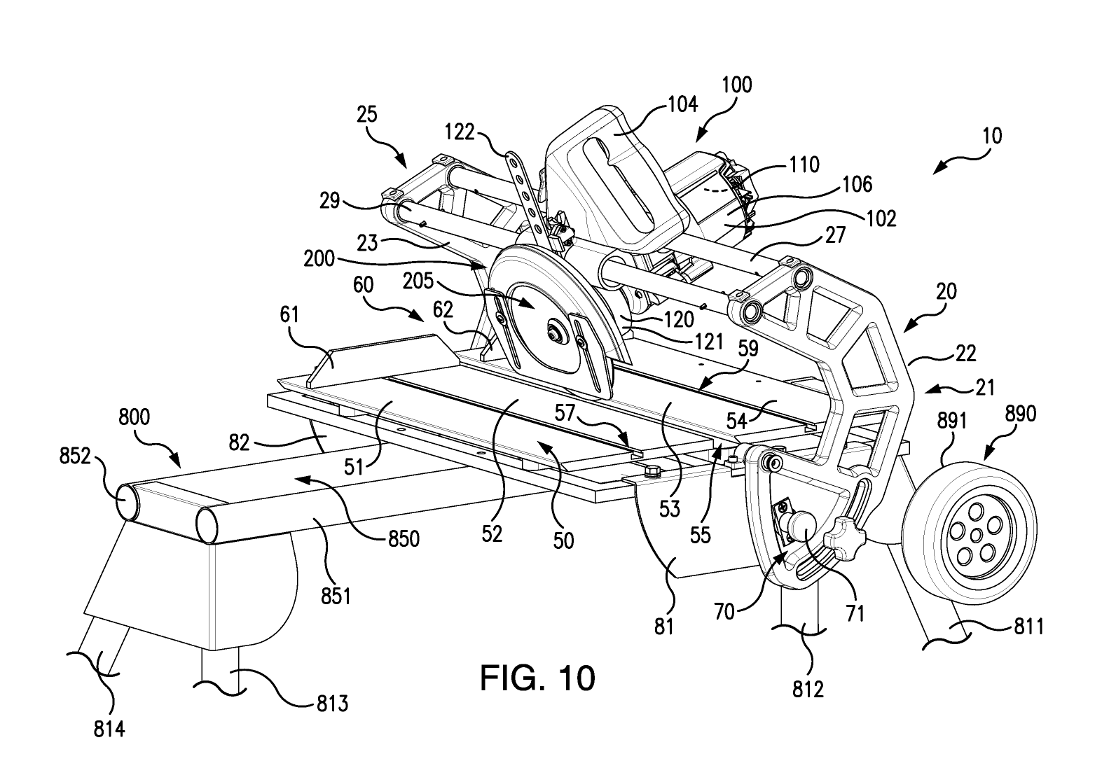

FIG. 1 shows an embodiment of the benchtop tool system 10 (FIG. 10) attachment interface 500 and connection section 600. In the embodiment of FIG. 1, the benchtop tool system 10 can have an attachment interface 500 which can be removably coupled to an attachment interface 500 of power unit 106 (FIG. 7). The attachment interface 500 power unit 106 can be driven by a power source and can turn the attachment interface 500 which drives a tool and/or tool head 200 (FIG. 7).

As shown in FIG. 1, a tool head can have an attachment interface 500 which is inserted into a base unit receiving portion 101 of the connection section 600 of a base unit 100, such as a connection housing 120 (also herein as “cavity housing 120”). The attachment interface 500 can be removed from the base unit receiving portion 101 of base unit 100 to remove the tool from the benchtop tool system 10 to allow another tool to be inserted to the base unit receiving portion 101 and used for other reason.

In an embodiment, the connection housing 120, or cavity housing 120, can have a cavity 125 into which at least a portion of the attachment interface 500 can be inserted and which can accommodate and/or cover at least a portion of the attachment interface 500.

In an embodiment, when the attachment interface 500 is inserted into a receiving portion, such as cavity housing 120, of a power unit 106, it can be reversibly secured for use. In nonlimiting example, one or both of the connection housing 120 and attachment interface 500 can be turned, moved or rotated so as to achieve a reversible coupling between the connection housing 120 and attachment interface 500 such that the power unit 106 can drive the tool head 200 which has been coupled for use. A tool can have an attachment interface 500 which can be removably secured to the connection section 600 of the power unit 106 which can drive the tool of the tool head 200.

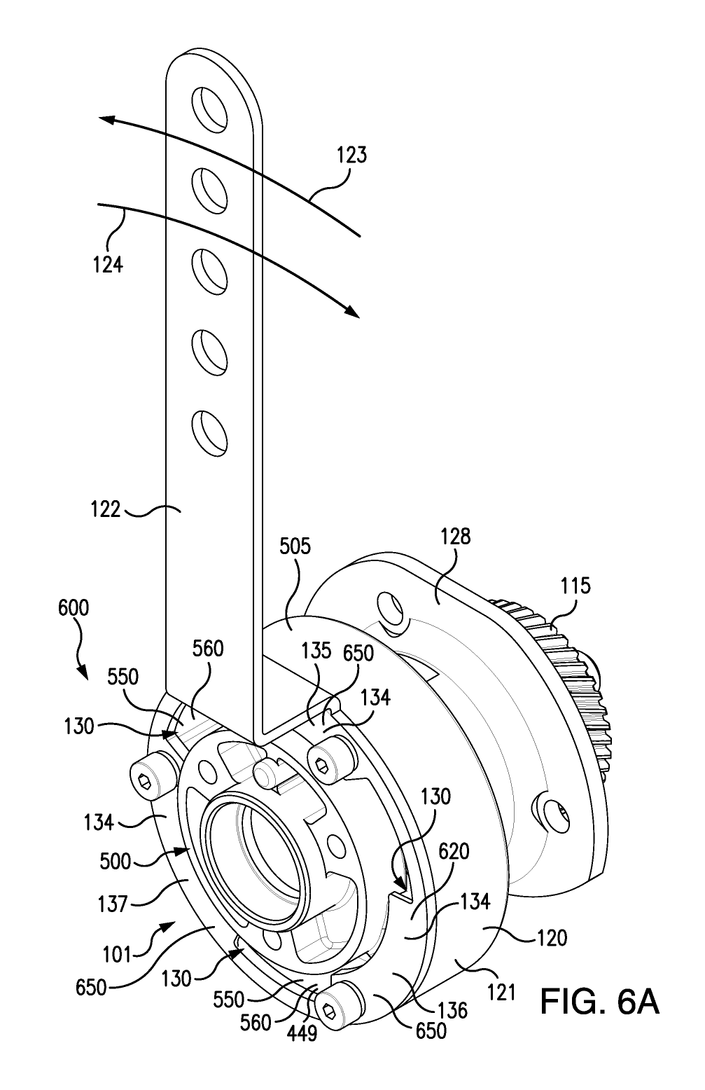

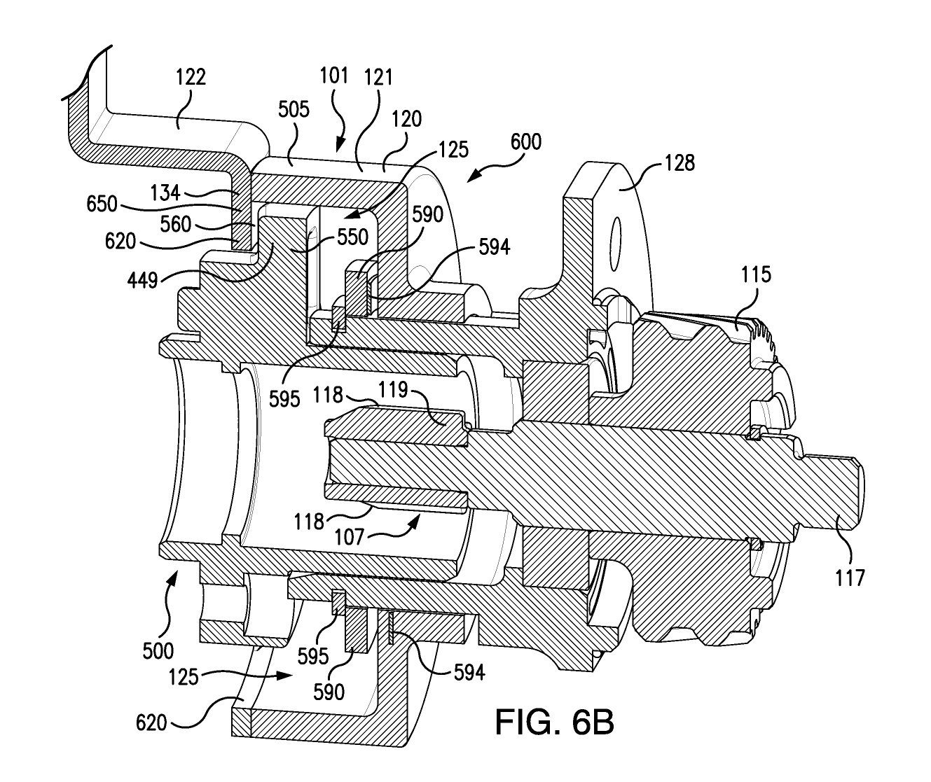

In one embodiment, the connection housing 120 can be rotated to lock and/or otherwise secure the attachment interface 500 for use of a given of the tool head 200. The example of FIG. 1 shows the connection housing 120 having a lock-down handle 122 which an operator can use to rotate the connection housing 120 to reversibly secure the attachment interface 500 (FIG. 6A). Such a securing can be reversed releasing the attaching member to be moved for removal or other purpose.

In another embodiment, the attachment interface 500 can be rotated and/or turned such that it reversibly locks and/or secures the tool head 200 with the interface housing 120. In another embodiment the coupling ring 121 can be turned or moved to ensure a reversible securing of the tool to the base unit 100.

FIG. 1 shows a nonlimiting example embodiment of the attachment interface 500 which has an interface body 505 and at least one of a lug 550. The attachment interface 500 of FIG. 1 can have three of a projection 449, such as the three of the lug 550, which can be a first lug 551, a second lug 552 and a third lug 553. In the embodiment of FIG. 1 each of the lugs 550 has a lug incline surface 560. For example, the first lug 551 can have a first incline surface 561, the second lug 552 can have a second incline surface 562, and the third lug 553 can have a third incline surface 563.

FIG. 1 also shows the connection housing 120 can have a cavity 125 for receiving the attachment interface 500. In the nonlimiting example of FIG. 1, the connection housing 120 can have a number of an opening 129, such as a housing opening 130 (through which a lug 550 can pass at least in part into the cavity 125. FIG. 1 shows a connection housing 120 having a first housing opening 131 which can correspond to the first lug 551, a second housing opening 132 which can correspond to the second lug 552, and a third housing opening 133 which can correspond to the third lug 553. The respective housing openings can be between anchors against which the lugs are pressed against at least a portion of the connection housing 120 when the attachment head is secured or in a secured position. For example, FIG. 1 shows a the first lock portion 135 (also as first connection anchor 135), a second lock portion. 136 (also as a second connection anchor 136) and a third lock portion 137 (also as a third connection anchor 137). FIG. 1 also shows a wave disc spring 590 which can press against a retaining ring 595. In an embodiment, the wave disc spring 590 can apply a force pressing the retaining ring 595 against the respective lugs when the attachment interface 500 is in a secured position.

FIG. 1 also shows a first rotatable coupler 107, such as a spindle gear 119 of a drive spindle 117. The drive spindle 117 can have one or more of a spline 118. The spindle gear 119 can be driven by the drive spindle 117 which can be driven by motor 110 of the power unit 106. The first rotatable coupler 107 can be engaged with a second rotatable coupler 507 (FIG. 17B) of the attachment interface 500.

FIG. 1 shows an embodiment having a plurality of a lock-down member 620 and a plurality of an opening 129. For example, FIG. 1 shows three of the connection anchor 134 and three of the opening 129.

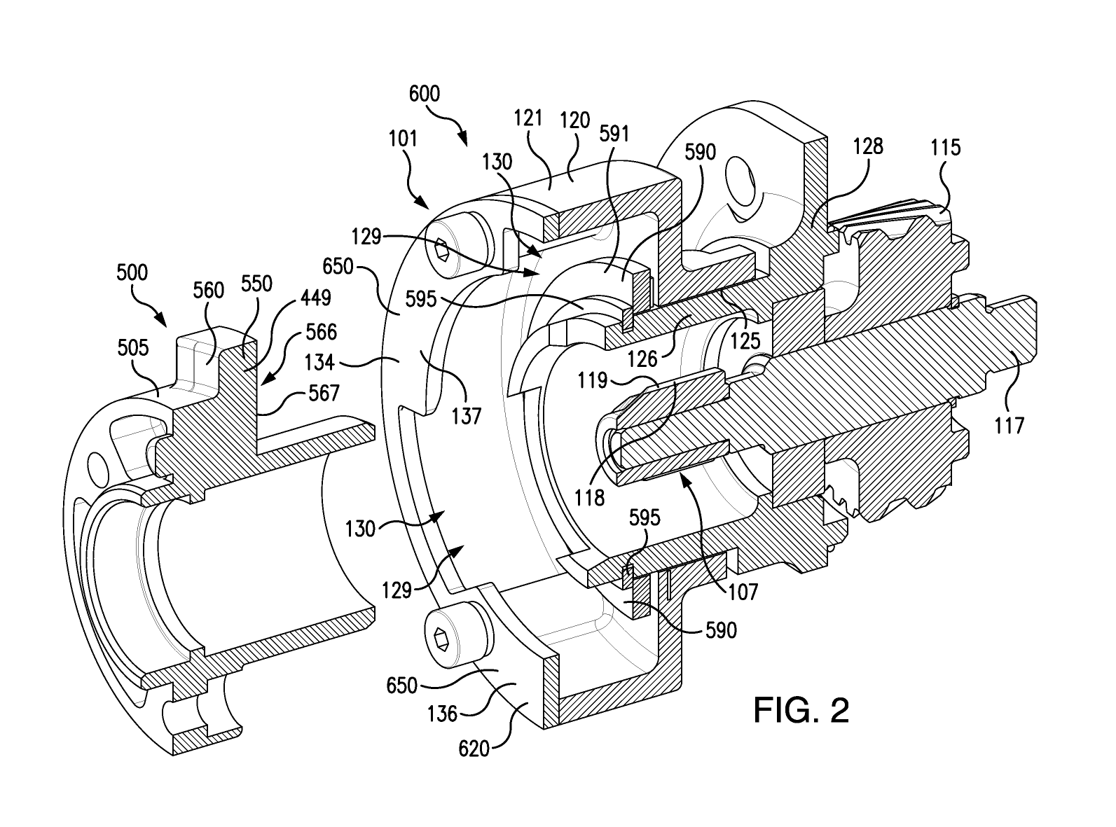

FIG. 2 shows a cross section of the benchtop tool system 10 attachment interface 500 and connection section 600. The rotatable coupler 507 (FIG. 17B) of the attachment interface 500.

In an embodiment, the attachment interface 500 and connection section 600 to power unit 106 can have a number of pieces which work together to secure a tool head 200 and provide power to the tool head 200. The motor 110 can drive base drive gear 115 which can turn the first rotatable coupler 107, such as an output spindle 117 which can have a spindle gear 119 which drives a tool head gear 201. Optionally, the spindle gear 119 can have a number of a spline 118.

In an embodiment the cavity 125 of the connection housing 120 can have a wave disc spring 590 which has a spring face 591.

FIG. 2 shows the output spindle gear 119 configured in a spindle housing portion 126.

The wave disc spring 590 can press the wave disc face 591 against the retaining ring 595 which can apply a force pressing the retaining ring 595 against one or more of the lug 550 of the attachment interface 500 to provide pressure to secure the attachment interface 500 when in a locked position. In an embodiment, the wave disc spring 590 can optionally press at least a portion of the wave disc face 591 against one or more of a lug face 567 against at least a portion of the connection housing 120. In an embodiment, the wave disc spring 590 can optionally press at least a portion of the thrust washing 594 against one or more of a lug face 567 against at least a portion of the connection housing 120.

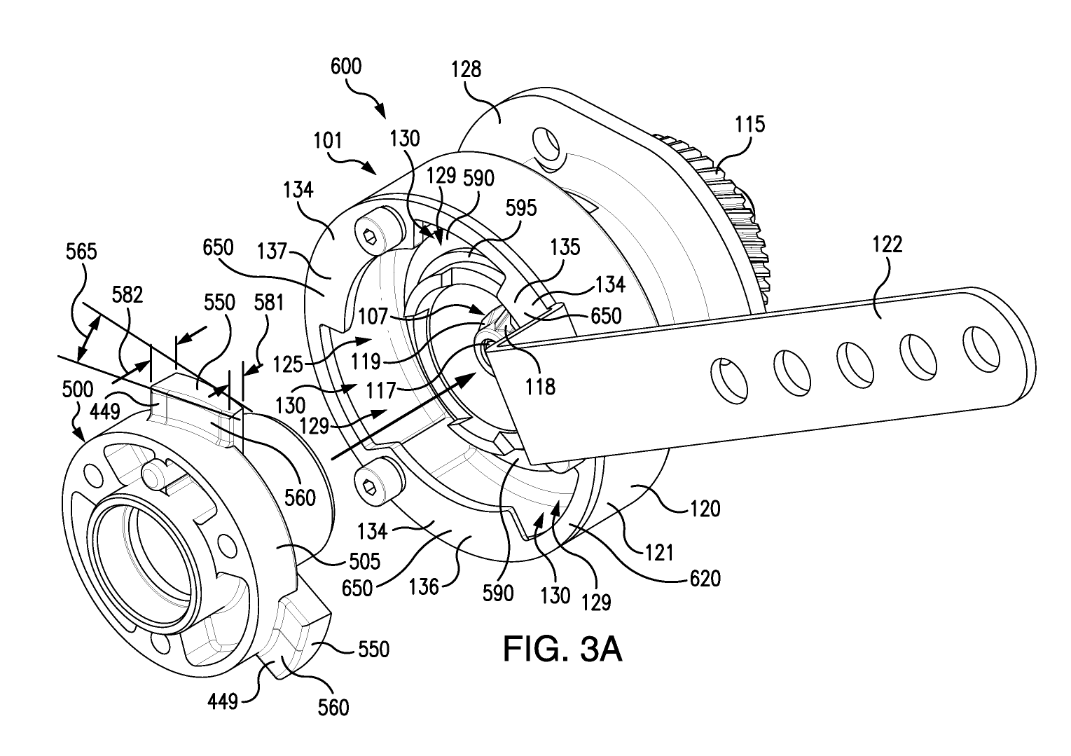

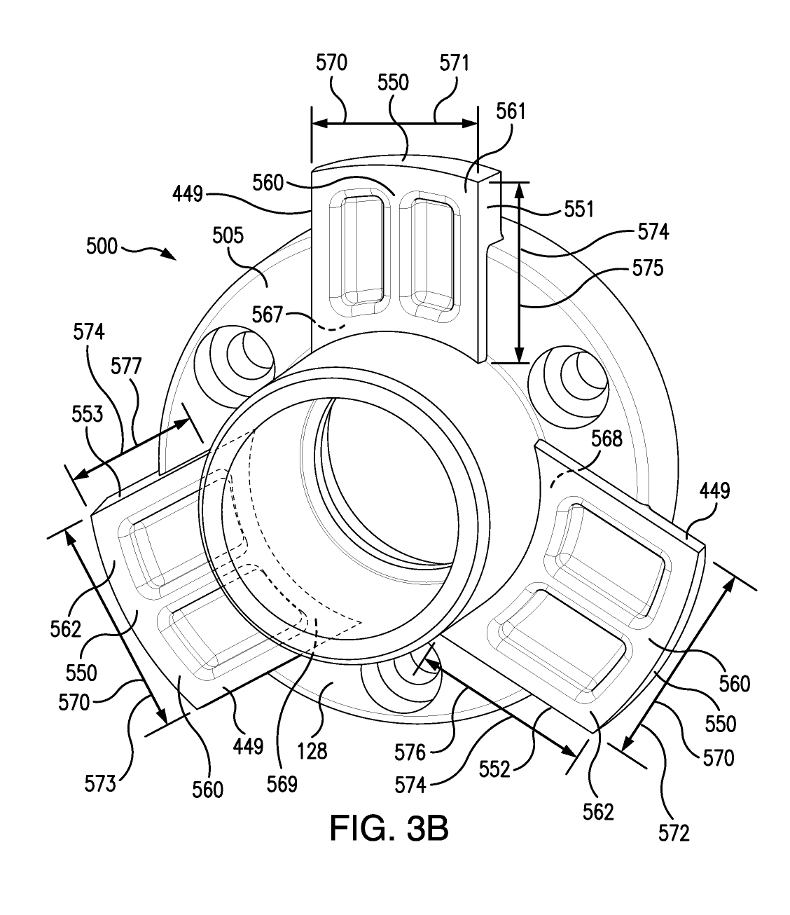

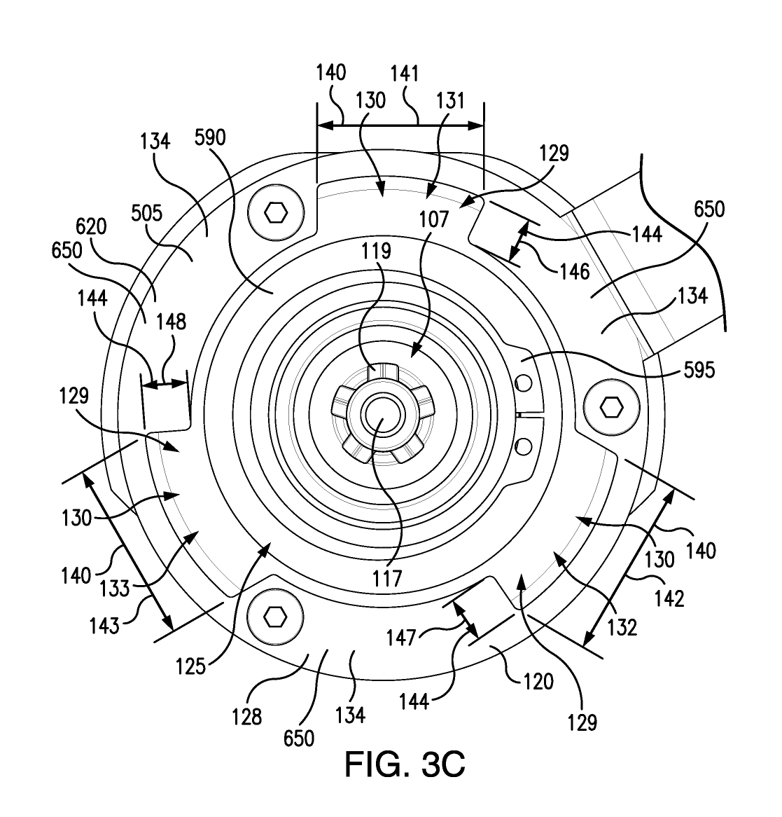

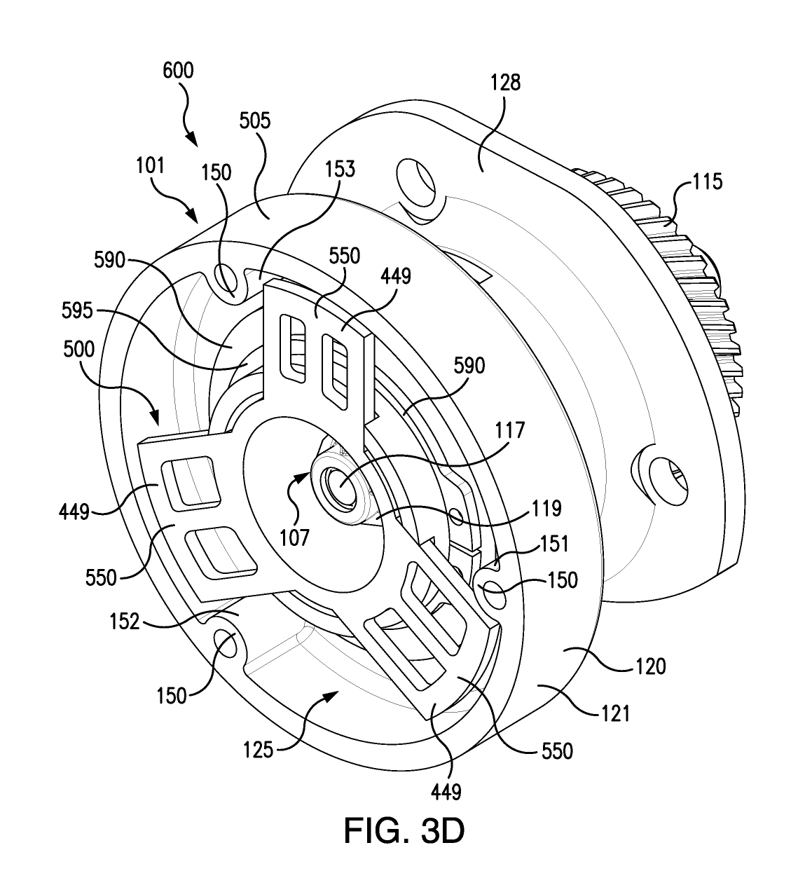

In the embodiment of FIG. 2, the wave disc spring 590 can press the wave disc face 591 against the retaining ring 595, and press the retaining ring 595 against each of the first lug face 567, the second lug face 568 (FIG. 3B) and the third lug face 569 (FIG. 3B). By the force exerted on these respective lug faces 561, 562 and 563, the lugs are pressed against respective lock portions 650 (also as connection anchors). For example, the first lug 551 is pressed against a first lock portion 135 (FIG. 1), the second lug 552 is pressed against a second lock portion 136, and the third lug 553 is pressed against a third lock portion 137.

As shown in FIG. 1, each of the lugs in FIG. 2 has a lug incline surface 560. In this nonlimiting example: when the lock-down handle 122 is moved and the connection housing is rotated from an unlocked position to a locked position, the first inclined surface 561 of the first lug 551 can be pressed against the first lock portion 135; the second inclined surface 562 of the second lug 552 can be pressed against the second lock portion 136; and the third inclined surface 563 of the third lug 553 can be pressed against the third lock portion 137.

The embodiment of FIG. 2 can also use: a coupling ring; a gear box hub; an output gear, such as base drive gear 115; an output spindle, such as base drive spindle 117; a ball bearing; and a coupling.

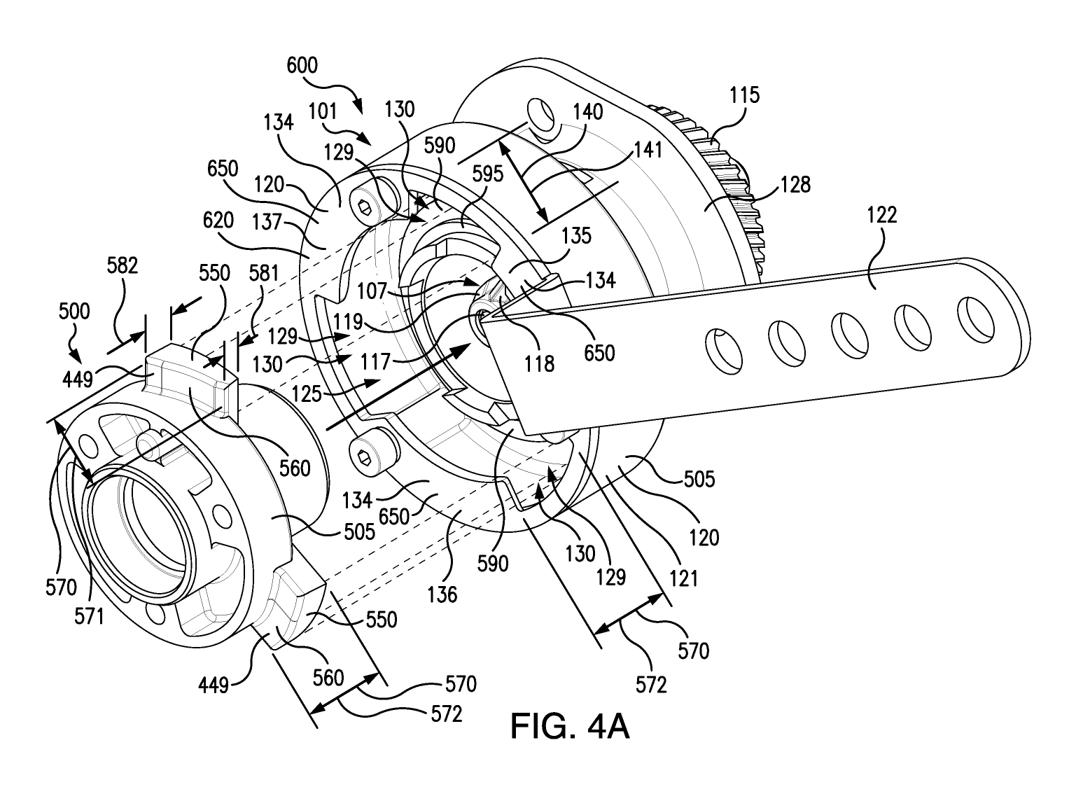

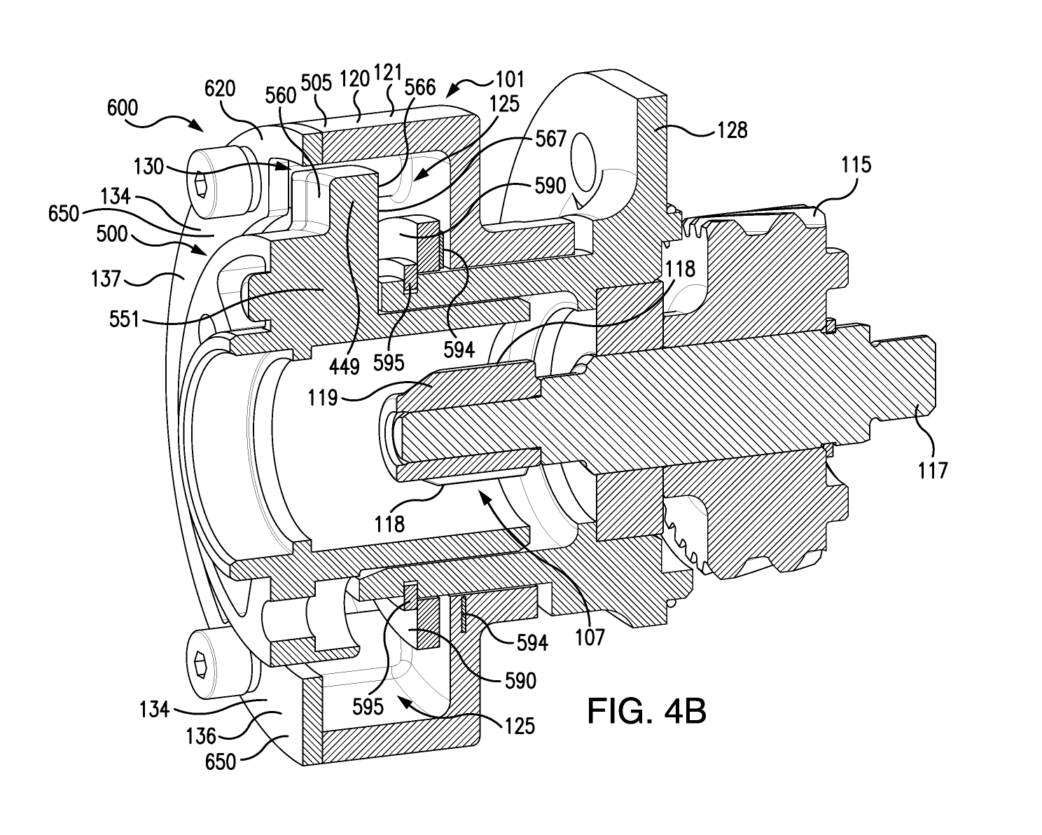

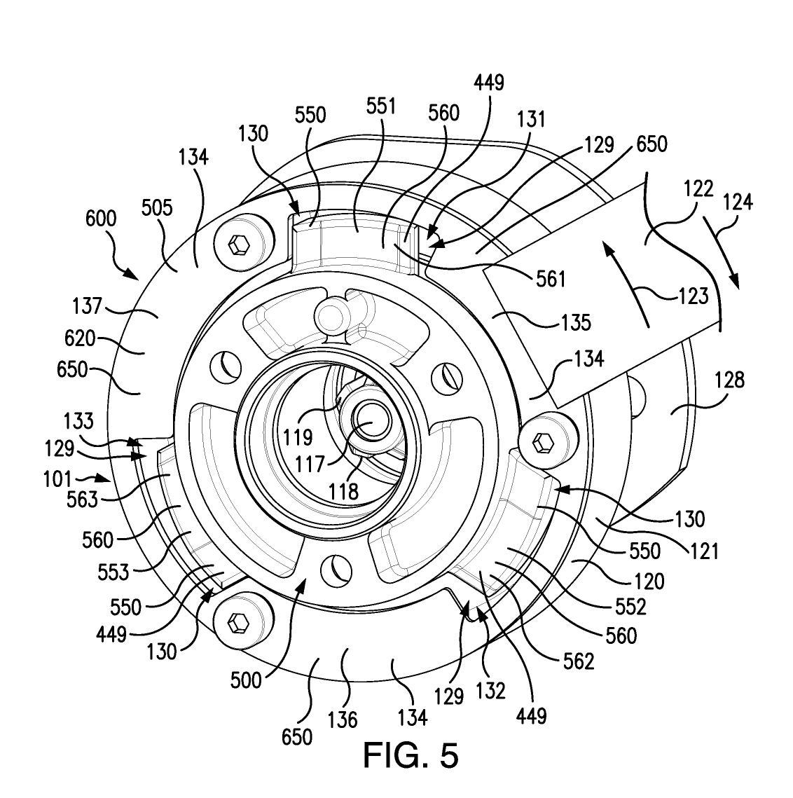

In an embodiment, the attachment interface 500, the coupling can be a male coupling, such as one or more of the lug 550. The connector section 600 can also have a lock-down handle 122 (FIG. 1), and a housing, such as connection housing 120, into which an attachment interface 500 can be removably inserted, meaning that the attachment interface 500 can be inserted and then later removed by a user. In an embodiment, the attachment interface 500 of a tool can have one or more lugs 550 (FIG. 5) which can be inserted through openings 129 (FIG. 5) to engage the interface housing 120 when rotated after insertion into the housing. In the embodiment, the fit of the attachment interface 500 can be made secure though the use of an optional thrust washer 594 (FIG. 4B) which can apply force to the wave disc spring 590, the wave disc spring 590 can apply force to the retaining ring 595 which applies force against the lugs 550 and presses them into at least a portion of the connection housing 600, such as the lock-down member 620. In an embodiment the interface housing 120 can have at least a portion of a coupling ring 121 and a cover piece which optionally can be at least a portion of the lock-down handle 122.

Optionally, any one or more of the thrust washer 594, the wave disc spring 590 and retaining ring 595 can be used to apply a force to at least a portion of the attachment interface 500 and to at least a portion of the interface housing 120, such as the lock-down member 620 or a lock portion 650.

In an embodiment, a thrust washer 594 (FIG. 4B) and/or a retaining ring can be used in conjunction with the wave disc spring 590 to enhance the security of the fit of the attachment interface 500.

FIG. 3A shows indexing features regarding the benchtop tool system 10 tool attachment interface 500. In an embodiment, a lug on the attachment interface 500 can be narrower in width than the other two. This can correspond with the attachment lock-down handle and the gear box hub. This can ensure that the tool head 200 can only mount to the power unit 106 in the desired orientation. In an embodiment a narrow width opening can be used to mate with a narrow width lug. FIG. 3A shows a detail of a lug 550 having a lug incline surface 560 at a lug incline angle 565 from the lug face 566. In an embodiment, when the lock-down handle 122 is turned the coupling ring 121 rotates a lock portion 134 (also as connection anchor 134) across the lug face 566. In the nonlimiting example of FIG. 3A, when the lock portion 134 rotates across the lug face 566, the lug 550 becomes locked between a lock portion 134 and the retaining ring 595. The rotation of the lock portion 134 in the opposite direction unlocks the lug 550 from the lock portion 134.

FIG. 3B shows a detailed top view of lug dimensions. In an embodiment the lugs 550 are respectively mated to the openings 130 (FIG. 3C) by matching a lug with 570 to a housing opening width 140 (FIG. 3C). By using one or more lug widths 570 which are different than the respective widths of the other lugs, a set orientation of mating a tool head 200 can be fixed for its insertion into connection housing 120 through housing opening widths 140 configured to accommodate the different respective lug widths 570.

FIG. 3B, shows an embodiment which has three lugs 550, each having a lug width 570 and a lug length 574. In the example of FIG. 3B: first lug 551 can have a first lug width 571 and a first lug length 575; second lug 552 can have a second lug width 572 and a second lug length 576; and third lug 553 can have a third lug width 573 and a third lug length 577. The respective lug widths 571, 572 and 573 can be the same or different. Optionally, the respective lug lengths 575, 576 and 577 can be the same or different. The lugs 550 can also each have a lug height 580, such as a first lug height 581, a second lug height 582 and a third lug height 583.

The lug width 570 and lug length 574 dimensions can be used to match with respective housing opening widths 140 to allow a fixed orientation of tool head 200 to be used when one or more dimensions is different than the others; or for flexibility of orientation of the attachment of the tool head 200 if the lug widths 570 have the same width and/or the lug lengths 574 have the same lengths.

FIG. 3C shows a detailed top view of housing opening 130 dimensions, each having a housing opening width 140 and an opening length 144. In the example of FIG. 3C: first opening 131 can have a first opening width 141 and a first opening length 146; second opening 132 can have a second opening width 142 and a second opening length 147; and third opening 133 can have a third opening width 143 and a third opening length 148. The respective opening widths 141, 142 and 143 can be the same or different. Optionally, the respective lug lengths 145, 146 and 147 can be the same or different. The openings used for each housing opening allow insertion of at least a portion of a corresponding lug 550. In an embodiment, one or more lugs 550 can have a different dimension than the other lugs 550. When one or more lugs 550 can have a different dimension than the other lugs 550, then one or more housing opening can have dimensions to accommodate insertion of the respective lugs 550. This allow for the orientation of the tool head 200 to be set, if desired, in order to achieve insertion of the attachment interface 500 into the connection housing 120, and coupling ring 121.

FIG. 3D shows a section view of the connection housing 120 with the lugs 550 configured in a locked position. FIG. 3D shows three lug stops 150: a first lug stop 151, a second lug stop 152 and a third lug stop 153.

FIG. 4A shows radial alignment features regarding the benchtop tool system 10 attachment interface 500.

In an embodiment, a snout with the lead-in chamfer on the attachment interface 500 can facilitate an operator in attaching a tool head 200 to the attachment interface 500 power unit 106's interface. This feature corresponds with the gear box hub. This can ensure that a tool head 200's female coupling is radially aligned with the power unit 106's male coupling. It is through the male and female couplings that power is transferred from the power unit 106 to the various tool head 200s. In an embodiment, the snout can be chamfered.

FIG. 4B shows a cross section of attachment interface 500 inserted into the connection housing 120 and oriented in an unlocked position.

FIG. 5 shows an axial lock mechanism to secure the benchtop tool system 10 attachment interface 500;

In an embodiment, the tool head 200 to the power unit 106 can be locked by the action of a user to rotate the lock-down handle 122 in locking direction 123. FIG. 5 shows a handle which has tabs which in turn ride up the ramps on the backside of the attachment interface 500's lugs. The attachment can be unlocked by rotating the lock-down handle in unlocking direction 124.

FIG. 6A shows additional details regarding the axial lock mechanism to secure the benchtop tool system 10 attachment interface 500.

In an embodiment, the attachment lock-down handle 122 and lock portion 650 can be fastened together such that when the unit is locked the lock portion 650 compresses the wave disc spring 590. The wave disc spring 590 can be held in place by the thrust washer and retaining ring on the gearbox hub. The compressed force of the wave disc spring 590 can be transferred to the lugs on the attachment interface 500 by means of the retaining ring 595, other member and/or directly, thus securely holding the tool head 200 to the power unit 106 when engaged in part or in full and/or when locked.

The attachment interface 500 can be loosened for turning and removal by unlocking the mechanism and releasing the force applied by the wave disc spring 590, and optionally also by the thrust washer 594.

FIG. 6A shows the assembly in the locked position. In this depiction the wave disc spring 590 is in the compressed state and the attachment lock-down handle has fully ridden up the ramps of the attachment interface 500.

FIG. 6B shows a cross section of the axial lock mechanism in a locked position to secure the benchtop tool system 10 attachment interface 500.

FIG. 7 shows a bench tool system 10 having a saw at a center position.

As shown in FIGS. 7-9 the base unit 100 can slide along on or more rails 25 and/or guides and/or supports. FIG. 7 illustrates an attached configuration of the tool head 200 which in this non-limiting example is a saw positioned at a center position along the rails 25 which guide it.

FIG. 8A shows a perspective view of a bench tool system 10 having a saw 299, which is show in nonlimiting example to be a circular saw 205 at a forward position.

FIG. 8B shows a circular saw tool head 205 which a cross section of the drive mechanism for the circular saw tool head 205 when it is in a coupled state with the connection housing 120 in which the base drive gear 115 can be turned by the motor 110 which can turn the spindle gear 119. The spindle gear 119 can mesh with a head gear 215 to impart rotational motion to the circular saw blade 207 about base drive gear rotational axis 1000 which can be coincidental to the circular saw axis of rotation 1100.

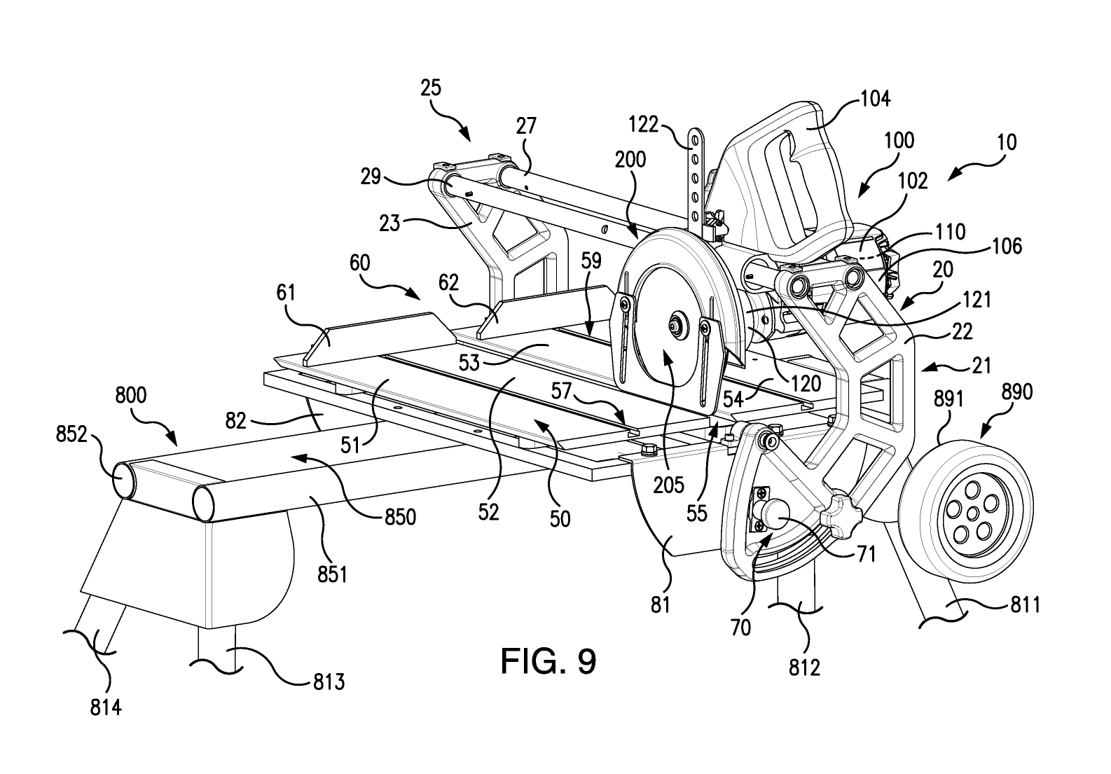

FIG. 9 shows a bench tool system 10 having a saw at a rearward position.

FIG. 10 shows a bench tool system 10 having a saw at a first beveled position. The bench tool system 10 can have a support arm 20 which can have one or more rails 25 which guide the base unit 100. The support arm 20 can be rotate and/or pivoted to achieve a desire angle by a tool's cutting member (e.g. a saw blade) or its contacting member to a workpiece (e.g. grinding surface, or other contacting member or piece). FIG. 10 shows the support arm 20 positioned to achieve a configuration beveled at 22.5°.

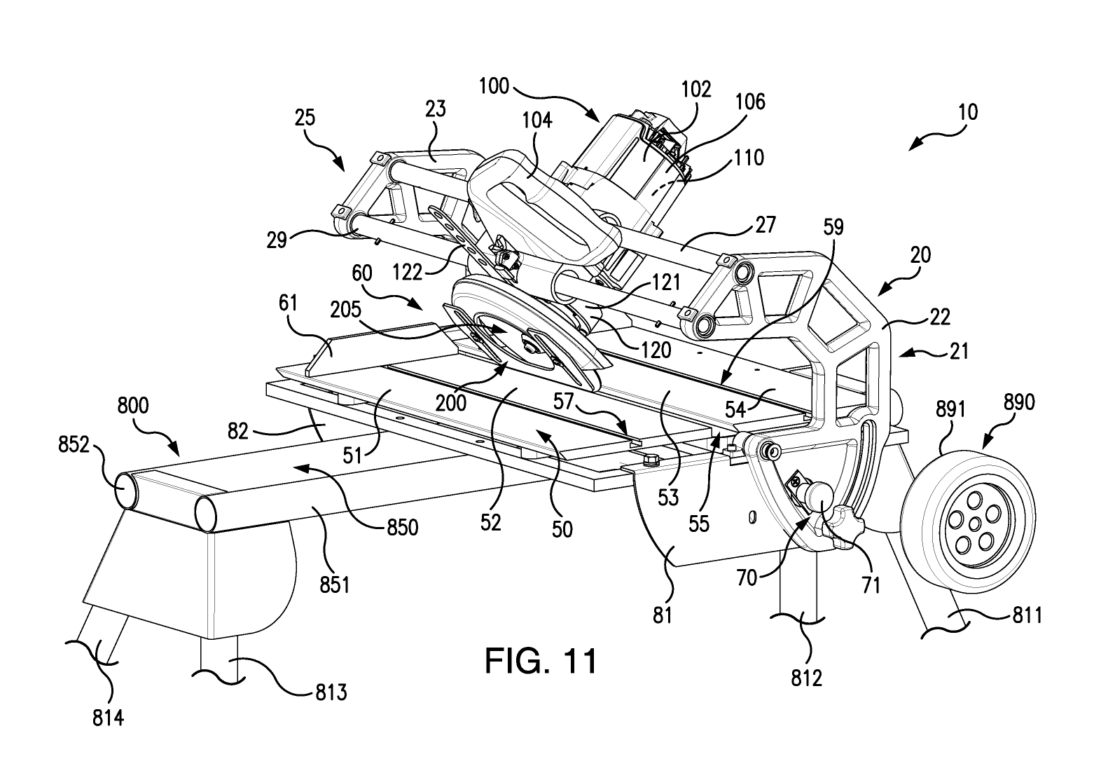

FIG. 11 shows a bench tool system 10 having a saw at a second beveled position. FIG. 11 shows the support arm 20 positioned to achieve a configuration beveled at 45°.

A wide variety of beveled configurations can achieved by moving, rotating and/or pivoting the support arm. The support arm can be configure to achieve a beveled angle in the range of from 0° to 180°, or 0° to 90°, or 10° to 90°, or 33° to 90°, or 45° to 90°, or 66° to 90°; such as 2°, 10°, 33°, 45°, 66°, or 90°. Angles such as 120° and 270° can also be used.

Numeric values and ranges herein, unless otherwise stated, are intended to have associated with them a tolerance and to account for variances of design and manufacturing. Thus, a number can include values “about” that number. For example, a value X is also intended to be understood as “about X”. Likewise, a range of Y to Z, is also intended to be understood as within a range of from “about Y to about Z”. Additionally, example numbers disclosed within ranges are intended also to disclose sub-ranges within a broader range which have an example number as an endpoint. A disclosure of any two example numbers which are within a broader range is also intended herein to disclose a range between such example numbers. Unless otherwise stated, significant digits disclosed for a number are not intended to make the number an exact limiting value. Variance and tolerance is inherent in mechanical design and the numbers disclosed herein are intended to be construed to allow for such factors. Likewise, the claims are to be broadly construed in their recitations of numbers and ranges.

FIG. 12 shows a bench tool system 10 having a saw tool head 299 (also herein synonymously with “saw”) attached. A wide array of tools can have an attachment interface 500 and be used with the benchtop tool system 10. FIG. 12 shows such a tool being a saw tool head 299. In FIG. 12 the saw head is attached. The tool attachment is removable to allow for various tools to be attached and detached from the base unit 100.

FIG. 13 shows a bench tool system 10 having a saw head in a detached configuration.

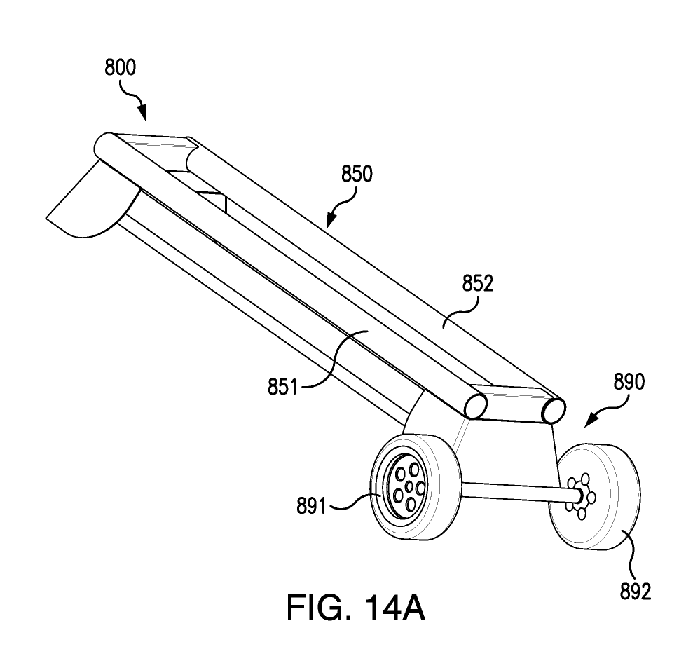

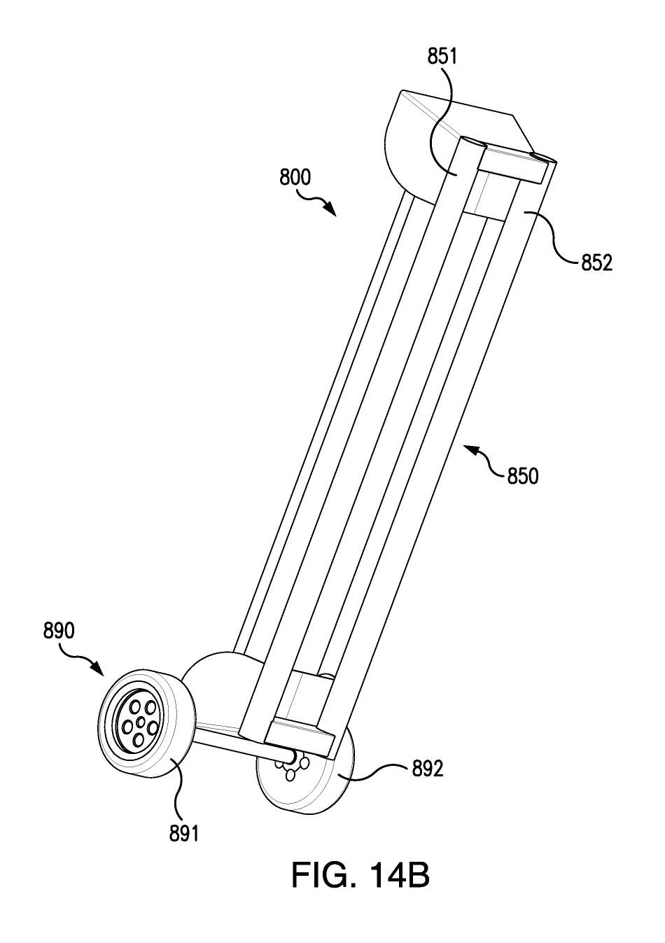

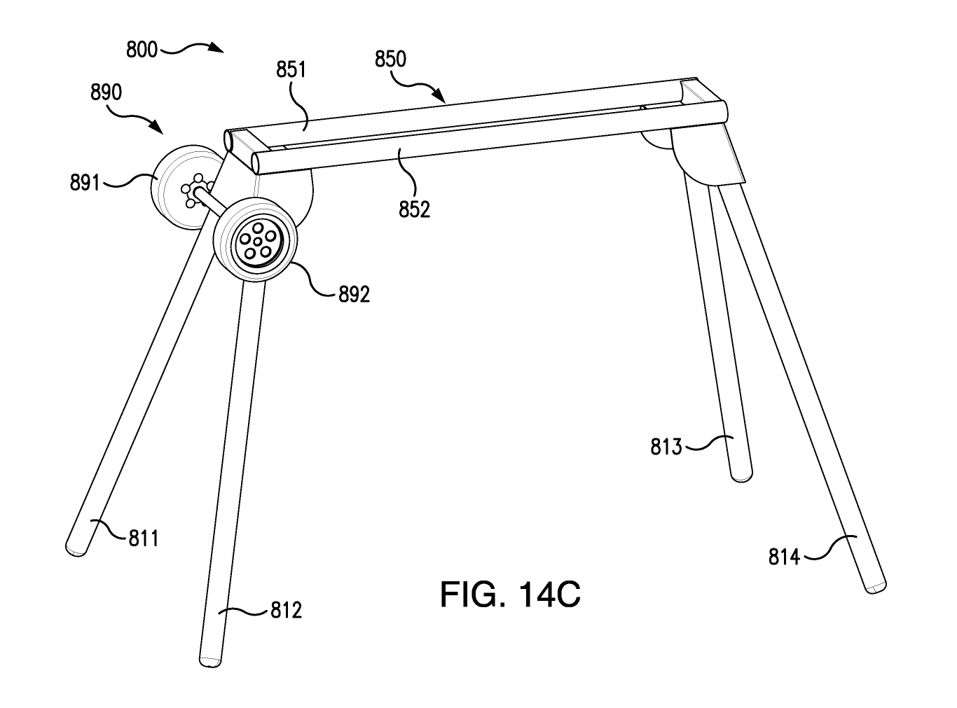

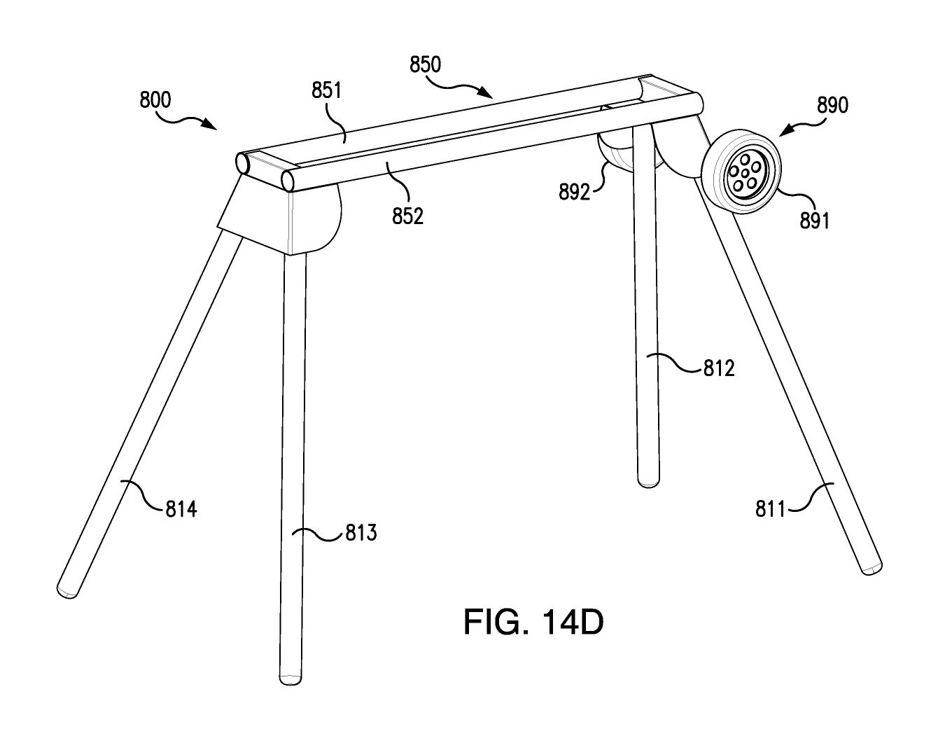

FIG. 14A shows a bench unit stand 800. In an embodiment the bench tool system 10 rests upon or has the bench unit stand 800 which is a detachable stand 805. This allows the operator to take the platform 50 apart from the detachable stand 805 and place it on any safe surface upon which to support it during work. For example, the platform 50 can be used when reversibly and/or removably attached to its detachable stand 805, such as detachable stand 805 and standing thereon.

In another embodiment, the platform 50 could be detached from the detachable stand 805 and placed on a table and/or other stable surface (or the ground) for use.

In an embodiment, the stand 800 can have wheels 890. The use of wheels 890 allows the user easier transport of the assembled unit or the stand alone. In an embodiment, one or more wheels 890 can be used. In an embodiment, the one or more wheels 890 can be configured on one end as show in FIG. 14A, and can have a first wheel 891 and a second wheel 892 for rolling the bench tool system 10 and bench unit stand 800 from one location to another.

FIG. 14A also show a platform support 850 upon which the platform 50 can be configured. The removable platform can be supported by platform support 850 and the bench unit stand 800 or used separate from the bench unit stand and placed upon another surface. In the embodiment of FIG. 14A, the bench unit stand 800 has a first platform support 851 and a second platform support 852.

FIG. 14B shows another perspective of a bench unit stand 800.

FIG. 14C shows a first perspective of a standing configuration of a bench unit stand.

FIG. 14D shows a second perspective of a standing configuration of a bench unit stand.

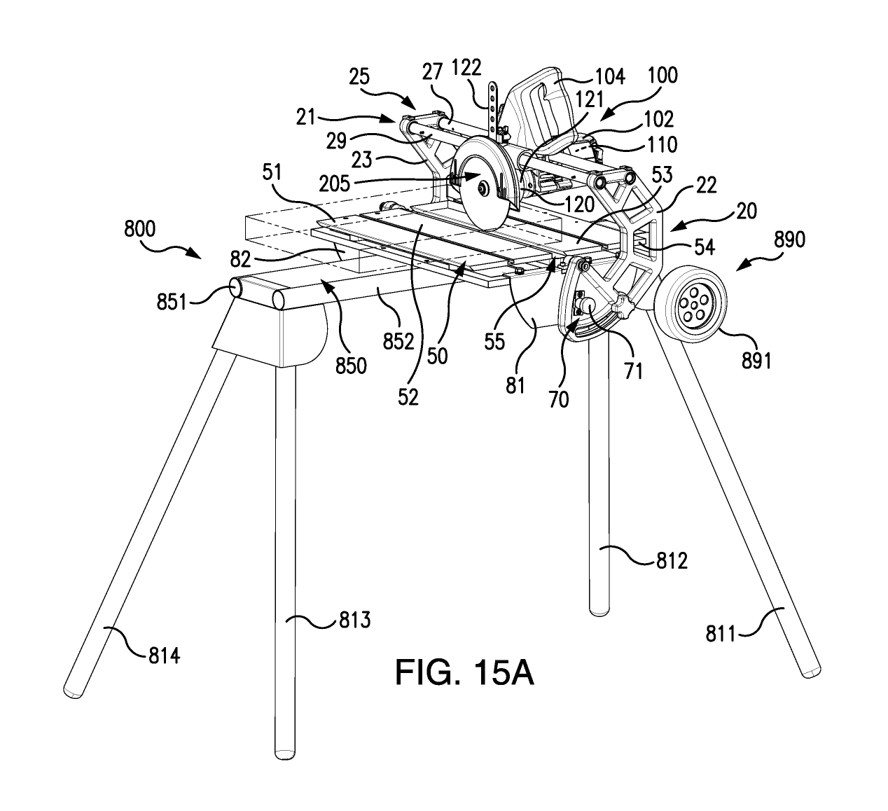

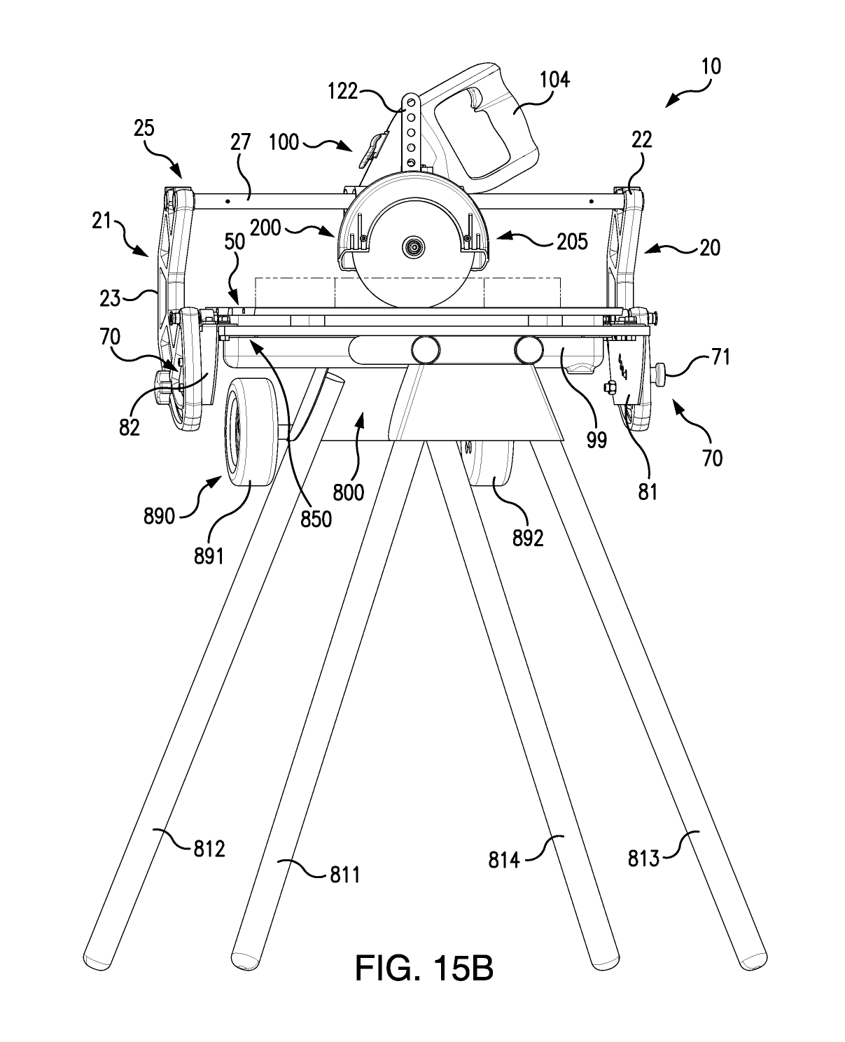

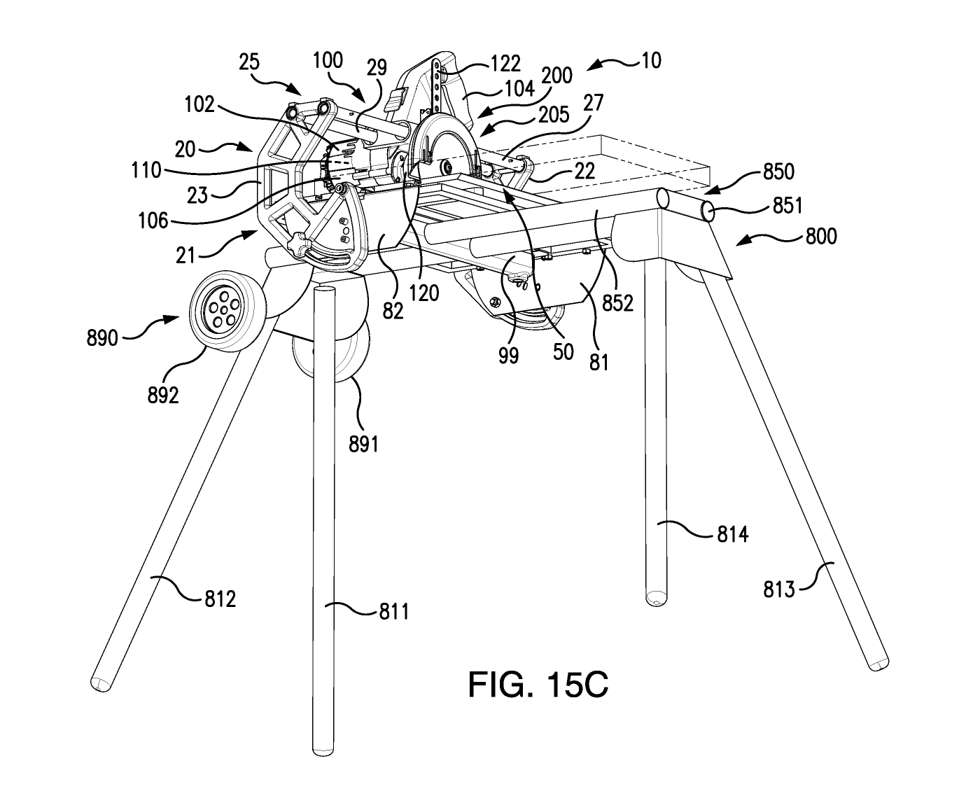

FIG. 15A shows additional details of the bench unit stand 800. As shown in FIG. 15, the working unit can be removed from the detachable stand 805 by a method of quick connect clamps and allow the user to operate the tool on any flat surface such as a table or the ground. This disclosure is not limited to the type of reversible connector used to secure the platform 50 to the detachable stand 805.

In an embodiment, one or more of the legs 810 can be adjustable in height. This can accommodate different operational environments and provide operators of different heights the ability to set the tool at a comfortable height. FIG. 15A show the legs 810 having a first leg 811, a second leg 812, a third leg 813 and a forth leg 814.

FIG. 15B shows an end view of the bench unit stand 800.

FIG. 15C shows a worm's eye view of the bench unit stand 800;

FIG. 16 shows a bench tool system 10 without a cutting head. The bench tool system 10 can accommodate a wide variety of tools and tool heads, such as, but not limited to, a circular saw, tile saw, grinder, cut-off tools, or a sander, which can have the attachment interface 500. FIG. 16 shows the base unit 100 which does not have any tool attached. In an embodiment, a plurality of rails 26 can be used. For example, FIG. 16 shows a first rail 26 and a second rail 27.

FIG. 16 also shows a platform 50 having a platform first surface 51, a platform second surface 52, a platform third surface 53 and a platform fourth surface 54. Table guides 60 are also shown.

In an embodiment, the bench tool system 10 can have side stands 80, such as first side stand 81 and second side stand 82.

FIG. 17A shows a bench tool system 10 with a tile saw tool head 210. In FIG. 17A, a tile saw tool head 210 (tile saw having an attachment interface 500) is shown attached to the base unit 100. The bench tool system 10 can have a broad variety of interchangeable tool heads, each of which can be a different tool, or a tool of a differing nature.

FIG. 17B shows a cross section of a tile saw tool head 210 in an attached configuration. FIG. 17B shows a cross section of the drive mechanism for the circular saw tool head 210 in a coupled state with the connection housing 120 in which one or the base drive gear 115 and more of a tile offset gears 212 can be turned by the motor 110 which can turn the spindle gear 119 which is coupled to a head gear 215. In the embodiment of FIG. 17B, the base drive gear 115 can drive the base drive spindle 117 and can drive the spindle gear 119. The spindle gear 119 can mesh with a head gear 215 which can drive a first offset gear 213 and a second offset gear 214, which can impart rotational motion to the tile saw blade 211. In an embodiment, the base drive gear rotational axis 1000 can be parallel with the a tile saw axis of rotation 1200.

As shown in FIG. 17B, an offset distance 1250 can be achieved by the use of the tile offset gears 212, or offset gears, or other gears. The offset distance 1250 of the embodiment of FIG. 17B is shown between the base drive gear rotational axis 1000 and the circular saw axis of rotation 1100.

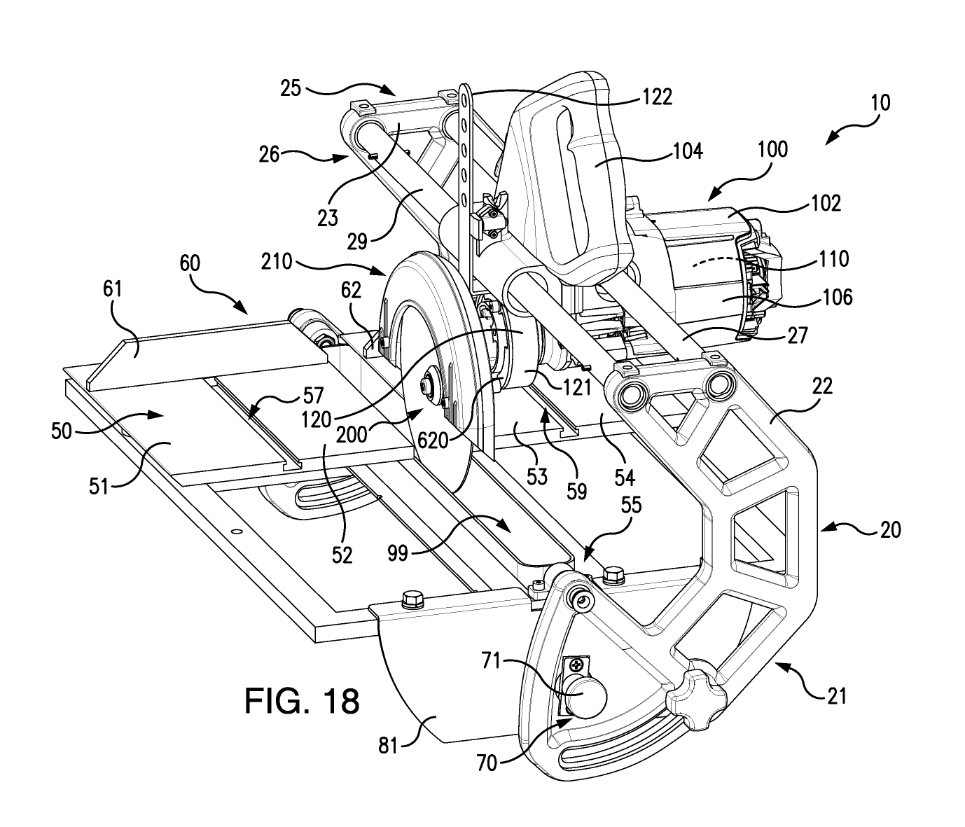

FIG. 18 shows a water trough 99 of a bench tool system 10. The bench tool system 10 can have a water trough 99 into which a tool portion can be contacted, such as a tile saw blade portion being wetted by water provided and/or held in the water trough 99. The water trough 99 can be filled by a user simply by pouring water into the trough. Optionally, the water trough 99 can be removable. The trough can be emptied by removing the trough and pouring out the water. The trough may also additionally have a hole and a removable plug which allows it to drain. The hole and the removable plug may be located at a bottom of the trough and in an embodiment is located at an end of the trough. When the plug is inserted to plug the hole, water remains in the water trough 99. Conversely, when the plug is removed, water is able to drain out of the water trough 99 through the hole. That nonlimiting example, of FIG. 18 shows a circular saw direction of rotation 1101 for the tool head 200 used in FIG. 18. The circular saw direction of rotation 1101 can be the same or different for other saws and/or tools and can be different for other embodiments of circular saws.

FIG. 19 shows a bench tool system 10 with a tile saw head at a beveled orientation. FIG. 19 also shows a portion of the tile saw blade positioned in the water trough 99 for wetting.

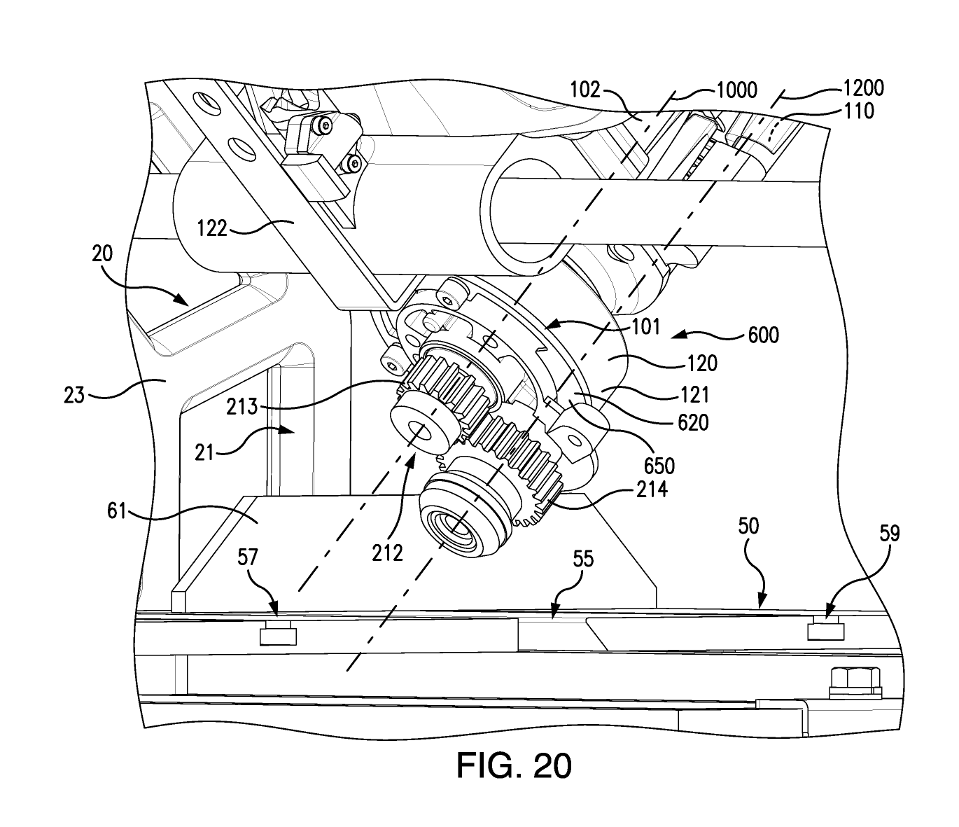

FIG. 20 shows tile offset tile saw offset gears 212. FIG. 20 shows a close up view of a first offset gear 213 and a second offset gear 214.

In an embodiment offset tile saw offset gears 212 can be used to achieve enhanced positioning and/or desired tool speeds.

This scope disclosure is to be broadly construed. It is intended that this disclosure disclose equivalents, means, systems and methods to achieve the devices, activities and mechanical actions disclosed herein. For each aspect, mechanical element or mechanism disclosed, it is intended that this disclosure also encompass in its disclosure and teaches equivalents, means, systems and methods for practicing the many aspects, mechanisms and devices disclosed herein. Additionally, this disclosure regards a bench tool system 10 and its many aspects, features and elements. Such a bench tool system 10 can be dynamic in its use an operation, this disclosure is intended to encompass the equivalents, means, systems and methods of the use of the tool and its many aspects consistent with the description and spirit of the operations and functions disclosed herein. The claims of this application are likewise to be broadly construed.

The description of the inventions herein in their many embodiments is merely exemplary in nature and, thus, variations that do not depart from the gist of the invention are intended to be within the scope of the invention. Such variations are not to be regarded as a departure from the spirit and scope of the invention.

We claim:

1. A benchtop tool system, comprising:
a platform configured to support a workpiece;
at least one rail having a base unit slidably mounted on the at least one rail, said base unit including a motor and a connection section;
a tool head which is a removable tool head and is connected to the base unit at the connection section.

2. The benchtop tool system of claim 1, wherein the tool head comprises an attachment interface receivable in the connection section.

3. The benchtop tool system of claim 2, wherein the connection section includes a first rotatable coupler drivable by the motor and the attachment interface is configured to allow passage of a second rotatable coupler coupleable to the first rotatable coupler.

4. The benchtop tool system of claim 2, wherein one of the attachment interface and the connection section comprises a projection and the other of the attachment interface and the connection section comprises an opening; and
wherein the projection and the opening are moveable with respect to one another from a first position in which the projection and the opening are aligned to a second position in which the projection and the opening are offset with respect to one another.

5. The benchtop tool system of claim 4, wherein when in the first position, the projection may pass through the opening so that the tool head can be moved towards or away from the base unit.

6. The benchtop tool system of claim 4, wherein when in the first position, the projection may pass through the opening so that the second rotatable coupler can be moved away from and out of engagement with the first rotatable coupler, or
the second rotatable coupler can be moved towards and into engagement with the first rotatable coupler.

7. The benchtop tool system of claim 4, wherein when in the second position, the projection is blocked and the tool head is prevented from being moved away from the base unit.

8. The benchtop tool system of claim 1, wherein the base unit further comprises a first rotatable coupler drivable by the motor and the tool head comprises a second rotatable coupler coupleable to the first rotatable coupler to be driven by the motor;
said first tool head having a first tool head tool which rotates in a first direction when coupled to the first rotatable coupler; and
said second tool head having a second tool head tool which rotates in a second direction when coupled to the first rotatable coupler, opposite the first direction.

9. The benchtop tool system of claim 1, wherein the connection section is configured for connection with each of a plurality of different types of the tool head which are interchangeable and which are selectably each individually connectable to the connection section and which are selectably removable from the connection section.

10. The benchtop tool system of claim 1, wherein the tool head comprises a saw, and the benchtop tool system operates as a saw when the second tool head is coupled to the base unit.

11. The benchtop tool system of claim 1, wherein the tool head comprises a circular saw, and the benchtop tool system operates as a circular saw when the second tool head is coupled to the base unit.

12. The benchtop tool system of claim 1, wherein the tool head comprises a tile saw and the benchtop tool system operates as a tile saw when the first tool head is coupled to the base unit.

13. The benchtop tool system of claim 1, wherein the tool head comprises a miter saw and the benchtop tool system operates as a miter saw when the first tool head is coupled to the base unit.

14. The benchtop tool system of claim 1, further comprising at least one support arm connecting the platform and the at least one rail, wherein the at least one rail and the at least one support arm are pivotable with respect to the platform.

15. The benchtop tool system of claim 1, wherein the tool head comprises an attachment interface receivable in the connection section.
wherein the connection section comprises a cavity for receiving the attachment interface;
wherein the connection section includes a lock-down member, comprising a plurality of openings separated by locking portions; and
wherein the connection section further comprises a first rotatable coupler driven by the motor.

16. A benchtop tool system, comprising:
a platform having a benchtop surface configured to support a workpiece;
at least one rail having a power unit having a motor slidably mounted on the at least one rail;
a connection section having a cavity and configured to removably receive an attachment interface of a tool head;
said connection section having a lock-down member comprising a plurality of openings separated by a plurality of locking portions;
said attachment interface having a plurality of projections adapted for passage through said plurality of openings when said attachment interface is received by said connection section;
when at least a portion of said attachment interface is received by said cavity, the lock-down member is selectably rotated to lock the position of said plurality of projections until the lock-down member is selectably rotated to unlock the position of said plurality of projections.

17. The benchtop tool system of claim 16, wherein the cavity is formed by a cavity housing; and
wherein the lock-down member forms at least a portion of the cavity and is rotatable with respect to a portion of an attachment interface.

18. A removable tool head for a tool system, the tool head comprising:
a tool head housing adapted to house at least a portion of a tool of a tool head having an attachment interface;
the attachment interface configured to attach to a base unit, the attachment interface comprising a generally cylindrical section through which a rotatable coupler passes, said rotatable coupler rotatable with respect to the generally cylindrical section,
a plurality of projections adapted for insertion into a cavity of a connector;
said plurality of projections projection radially outwardly from at least the first generally cylindrical section.

19. The tool head of claim 18, wherein the plurality of projections comprise lugs having an inclined surface and adapted for locking in place by said connector.

20. The tool head of claim 18, wherein the rotatable coupler comprises a female coupler configured to receive at least a portion of a rotatable male coupler.
